(19) United States
(12) Patent Application Publication
(10) Pub. No.: US 2018/0243924 A1
(43) Pub. Date: Aug. 30, 2018

(54) TACTILE SENSORS AND METHODS OF FABRICATING TACTILE SENSORS

(71) Applicants: THE REGENTS OF THE UNIVERSITY OF CALIFORNIA, OAKLAND, CA (US); DREXEL UNIVERSITY, PHILADELPHIA, PA (US)

(72) Inventors: Yon Jason Visell, Philadelphia, PA (US); Bin Li, Norwalk, CT (US)

(21) Appl. No.: 15/758,551

(22) PCT Filed: Sep. 8, 2016
(86) PCT No.: PCT/US16/50769

§ 371 Date: Mar. 8, 2018

Related U.S. Application Data
(60) Provisional application No. 62/215,354, filed on Sep. 8, 2015.

(51) Int. Cl. B25J 13/08; G01L 1/14; G01L 5/22; G01L 1/00

(52) U.S. Cl. CPC B25J 13/084; G01L 1/005; G01L 5/228; G01L 1/146

(57) ABSTRACT

Embodiments of the present disclosure describe a tactile sensor comprising an elastomeric membrane having a channel formed therein, a liquid conductive material located in the channel, and electrodes electrically connected to the liquid conductive material, sufficient to form a stretchable electronic tactile sensor, wherein the stretchable electronic tactile sensor can be stretched over 50% in at least two axial directions from a resting state of the stretchable electronic tactile sensor. Embodiments further describe a method of fabricating a tactile sensor comprising providing a mold for fixing a plurality of filaments in parallel on a first plane and on a second plane; casting a curable material into the mold; curing the curable material to form a membrane; extracting the plurality of filaments from the membrane to form microfluidic channels in the membrane; and functionalizing the membrane by introducing a conductive liquid into the microfluidic channels of the membrane.

### TECHNICAL FIELD

The present invention is directed to the field of sensors. In particular, the invention is directed to sensors used in stretchable material.

### BACKGROUND

Tactile sensors generally can electronically sense mechanical stimuli felt during active touch perception of objects through physical contact, similar to human touch. To operate in unconstrained environments, a tactile sensor should be compliant and adaptable to the surfaces involved. During touch interaction with real-world objects, contact surfaces are generally non-planar, curved, and compliant. Contact surfaces can also change dynamically according to the shape of the hand and/or geometry of the contact. Most tactile sensors that have been developed, however, utilize stiff substrates that cannot deform significantly without failure. Even those devices that can flex, such as devices that use flexible electronic substrates, can impair tactile sensing because they impede the capture of shear strains, making it difficult to maintain slip-free contact during shear interactions with a contact surface, as commonly observed in touching, grasping, object lifting, and manipulation. These devices are further limited due to the strong coupling of electronic and mechanical effects frequently observed in these devices.

Current designs and methods of fabricating stretchable sensor arrays observe numerous shortcomings, as well. At present, methods of fabricating stretchable sensor arrays produce devices that fail within a specified operating range of forces. In addition, the devices cannot meet application-dependent electronic and mechanical performance requirements. For instance, fabricated soft, solid cast capacitive sensors are theoretically and empirically limited due to the existence of non-monotonic regime at low strains, as well as mechanically-induced cross-talk, strain-rate dependence, hysteresis, and strain-induced channel collapse and electrical failure. These effects cannot be avoided by altering the material or geometry, for example, due to the dependence of electronic measurements on volumetric strain.

Several strategies for designing flexible sensing arrays have emerged through the efforts of researchers in robotics, biomedical engineering, and materials engineering. They have most commonly been based on embedding electronic strain sensors, including resistive strain gauges, optical fibers, capacitance sensors, or other semiconducting materials, into elastic media. None of these approaches yields a device that is stretchable enough to conform to biological tissues. Devices based on these principles are likewise not able to remain functional under large strains. Due to the lack of stretchability, the resulting sensors cannot accurately transduce distributed finite-strain information, such as the information produced during palpation. Also these devices cannot transmit the distributed finite-strain information to the skin of a wearer, and cannot conform to the skin of a wearer without imposing undesirable deformation.

While there exist a number of attempts to provide sensors for use in tactile sensing, there still remains a need to provide a highly stretchable tactile sensor array that is capable of providing high resolution sensing.

### SUMMARY

In general, embodiments of the present disclosure describe tactile sensors and methods of fabricating tactile sensors.

Accordingly, embodiments of the present disclosure describe a tactile sensor comprising an elastomeric membrane having a channel formed therein, a liquid conductive material located in the channel, and electrodes electrically connected to the liquid conductive material, sufficient to form a stretchable electronic tactile sensor, wherein the stretchable electronic tactile sensor can be stretched over 50% in at least two axial directions from a resting state of the stretchable electronic tactile sensor.

Embodiments of the present disclosure also describe a tactile sensor comprising an elastomeric membrane, the elastomeric membrane including a first parallel array of microfluidic channels and a second parallel array of microfluidic channels, the first parallel array of microfluidic channels aligned perpendicular to the second parallel array of microfluidic channels; and a conductive liquid in the first and second parallel arrays of microfluidic channels.

Embodiments of the present disclosure further describe a method of fabricating a tactile sensor comprising providing a mold for fixing a plurality of filaments in parallel on a first plane and on a second plane, the filaments of the first plane aligned orthogonally to the filaments of the second plane; casting a curable material into the mold; curing the curable material to form a membrane; extracting the plurality of filaments from the membrane to form microfluidic channels in the membrane; and functionalizing the membrane by introducing a conductive liquid into the microfluidic channels of the membrane.

The details of one or more examples are set forth in the description below. Other features, objects, and advantages will be apparent from the description and from the claims.

### BRIEF DESCRIPTION OF DRAWINGS

This written disclosure describes illustrative embodiments that are non-limiting and non-exhaustive. In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

Reference is made to illustrative embodiments that are depicted in the figures, in which:

FIG. 1 illustrates a diagram of a resistive sensor, according to one or more embodiments of the present disclosure.

FIGS. 2A and 2B show diagrams of two different embodiments of capacitive sensors, according to one or more embodiments of the present disclosure.

FIGS. 3A-3B depict the model of the mutual capacitance between the two orthogonal conductive channels employed in Example 1, according to one or more embodiments of the present disclosure. FIG. 3A shows a three dimensional view of the channels and FIG. 3B shows a section of the channels illustrating the geometric parameters employed in the model, according to one or more embodiments of the present disclosure.

FIGS. 4A and 4B show diagrams of two different geometrical configurations of resistive sensors, according to one or more embodiments of the present disclosure.

FIGS. 5A-5D show diagrams of the geometrical configurations of a resistive sensor under different pressures, according to one or more embodiments of the present disclosure.

FIG. 6 is a graph of resistance versus pressure for the resistance of a channel, according to one or more embodiments of the present disclosure.

FIG. 7 is a schematic diagram showing active addressing, according to one or more embodiments of the present disclosure.

FIG. 8 is a schematic diagram showing passive addressing, according to one or more embodiments of the present disclosure.

FIGS. 9A-9C are diagrams showing three different patterns that may be used in the formation of stretchable electronic tactile sensors, according to one or more embodiments of the present disclosure.

FIGS. 10A-10B are diagrams of two different patterns that may be used in the formation of stretchable electronic tactile sensors, according to one or more embodiments of the present disclosure.

FIGS. 11A-11G are diagrams of several different patterns that may be used in the formation of stretchable electronic tactile sensors, according to one or more embodiments of the present disclosure.

FIG. 12 is a diagram of a pattern that may be used in the formation of stretchable electronic tactile sensors, according to one or more embodiments of the present disclosure.

FIG. 13 shows a process of making a resistive stretchable electronic tactile sensor, according to one or more embodiments of the present disclosure.

FIGS. 14A-14D show resistive stretchable electronic tactile sensors, according to one or more embodiments of the present disclosure.

FIG. 15 shows the process of making a resistive stretchable electronic tactile sensor, according to one or more embodiments of the present disclosure.

FIGS. 16A-16D show capacitive stretchable electronic tactile sensors, according to one or more embodiments of the present disclosure.

FIGS. 17A-17D show views of the mold used in fabricating the stretchable electronic tactile sensors, according to one or more embodiments of the present disclosure.

FIGS. 18A-18D show fluorescence confocal microscope photographs for silicone rubber and the casting mold, according to one or more embodiments of the present disclosure.

FIGS. 19A-19C show the experimental set-up used in testing stretchable electronic tactile sensors, according to one or more embodiments of the present disclosure.

FIGS. 20A-20B are graphs of the resistance versus load mass of resistive stretchable electronic tactile sensors using different conductive fluids, according to one or more embodiments of the present disclosure.

FIGS. 21A-21C show the experimental set-up for measuring using a capacitive sensor, according to one or more embodiments of the present disclosure.

FIG. 21D shows measurements obtained from a capacitive four element sensor as shown in FIGS. 21A-21C, according to one or more embodiments of the present disclosure.

FIG. 22A illustrates the procedure for capacitive sensor array fabrication, based on direct filament casting and 3D photopolymer printing, according to one or more embodiments of the present disclosure. In FIG. 22A the steps shown are: 1) cast filaments having a diameter of 300 μm were coated with release agent by spray coating (Ease Release 200™, Smooth-On, Inc.) and dried at room temperature; 2) the filament fixture mold was modeled in CAD and prepared using a photopolymer 3D printer (Object30(a)™, Stratasys Ltd.), subsequently cleaned with isopropanol alcohol, then baked at 65° C. for 3 hours to eliminate any residual composites that would interfere with the silicone curing; 3) the release agent coated filaments were fixed in parallel on two planes that aligned perpendicular to one another; 4) uncured silicone rubber (Ecoflex 00-30™, Smooth-On, Inc.) was degassed under vacuum pressure (−29 inHg); 5) the degassed silicone rubber was cast into the mold and after a complete cure is achieved, the filaments are extracted under tension, leaving open channels in the silicone membrane; 6) the demolded membrane was transferred to a sealing mold, and 7) all open channels were sealed in an edge filling casting step. Shown in h), after the complete curing of the sealing material, eGaln was injected into the channels via syringe, and i) fine electrodes were inserted, forming an electrical connection with the eGaln.

FIG. 22B is a photograph showing the casting mold with filaments for making the capacitive sensing array reference in FIG. 22A, according to one or more embodiments of the present disclosure.

FIGS. 23A-23B show a soft, capactive stretchable tactile sensing array that was fabricated via the direct filament casting in accordance with Example 1, according to one or more embodiments of the present disclosure.

FIG. 23C depicts a single capacitive element of the sensing array of FIGS. 23A-23B, according to one or more embodiments of the present disclosure.

FIG. 23D shows an 8×8 microchannel array for a capacitive sensor that is embedded in a silicone rubber membrane with dimensions of 4 cm×4 cm×3 mm. The channels have a circular cross-section with a diameter of 300 μm, according to one or more embodiments of the present disclosure.

FIGS. 23E-23F show the capacitive sensing array of FIGS. 23A-23B conforming to a sphere of 1 cm diameter and a human finger, respectively, according to one or more embodiments of the present disclosure.

FIG. 24 illustrates a top view of a stretchable tactile sensor, according to one or more embodiments of the present disclosure.

FIG. 25 illustrates a sectional view of a stretchable tactile sensor showing an upper channel, a lower channel, free space, and micropillars, according to one or more embodiments of the present disclosure.

FIG. 26(a) illustrates a top view of a 9×9 sensing array, according to one or more embodiments of the present disclosure.

FIG. 26(b) illustrates a magnified top view of a stretchable tactile sensor showing the configuration of microchannels and micropillars, according to one or more embodiments of the present disclosure.

FIG. 26(c) illustrates a sectional view of a stretchable tactile sensor showing the stretchable tactile sensor's multilayer structure, according to one or more embodiments of the present disclosure.

FIG. 26(d) illustrates a sectional view of a stretchable tactile sensor showing the stretchable tactile sensor's multilayer structure, according to one or more embodiments of the present disclosure.

FIG. 27 illustrates a block flow diagram of a method of fabricating a stretchable tactile sensor, according to one or more embodiments of the present invention.

FIG. 28 shows the change in capacitance with increasing load as measured in Example 2, compared with predictions of the model of Eq. 1, demonstrating excellent qualitative and quantitative agreement over the displayed range, according to one or more embodiments of the present disclosure.

FIGS. 29A-29F show tactile imaging using a fabricated capacitive stretchable sensing array with different indentation patterns, according to one or more embodiments of the present disclosure. FIG. 29A depicts the configuration of the experimental vertical indentation set-up with a circular indentation plate having a 4 mm diameter, according to one or more embodiments of the present disclosure. FIGS. 29B-29C show the capacitance change imaging under circular plate indentation, according to one or more embodiments of the present disclosure. Discrete measurements at each sensing element are interpolated. Two indentation depths d are shown, 1.88 mm (FIG. 29B) and 2.41 mm (FIG. 29C). FIGS. 29D-29E show the interpolated capacitance change image from a plastic four-point indentation pattern, according to one or more embodiments of the present disclosure. Two indentation depths d are shown, 1.88 mm (FIG. 29D) and 2.41 mm (FIG. 29E). FIG. 29F shows an image obtained from a cross-shaped indentation tip. Dashed lines in each image show the indentation stamp profile, according to one or more embodiments of the present disclosure.

FIGS. 30(a)-(b) illustrate a schematic diagram of the procedure for fabricating the upper part and lower part, respectively, of a stretchable tactile sensor, according to one or more embodiments of the present disclosure.

FIG. 30(c) illustrates a schematic diagram of the procedure for aligning and bonding the upper and lower parts of a stretchable tactile sensor, according to one or more embodiments of the present disclosure.

FIG. 30(d) illustrates a schematic diagram of the procedure for functionalizing the sensing array by filling channels of a stretchable tactile sensor with eGaln and inserting electrodes to form the electronic interface, according to one or more embodiments of the present disclosure.

FIG. 31(a) illustrates a perspective view of the structure of the simulated model, according to one or more embodiments of the present disclosure.

FIG. 31(b) illustrates a cross-sectional view of displacement along a 45° diagonal section, according to one or more embodiments of the present disclosure.

FIGS. 31(c)-(d) illustrate a top view of the displacement and stress, respectively, of the sensing cell under compression and its surrounding micropillars, according to one or more embodiments of the present disclosure.

FIG. 31(e) illustrates a graphical view of capacitance change (%) with normal indentation (μm), according to one or more embodiments of the present disclosure.

FIG. 32 illustrates a schematic diagram of indenting tips used for characterization and an image of the programming mechanical testing system used in the experiments, according to one or more embodiments of the present disclosure.

FIG. 33(a) illustrates a graphical view of a measured change (black dot) in capacitance as a function of strain (μm) showing good agreement with simulations (dashed line) and also showing measured force (μN) (starred dots), according to one or more embodiments of the present disclosure.

FIG. 33(b) illustrates a graphical view of the change in capacitance as a function of force showing a linear relationship up to 20 μN, according to one or more embodiments of the present disclosure.

FIG. 33(c) illustrates a graphical view of the change in capacitance as a function of displacement (μm) showing the hysteresis of forward and backward indenting cycle, according to one or more embodiments of the present disclosure.

FIG. 33(d) illustrates a graphical view of the change in capacitance as a function of displacement (μm) showing sensor response to strain applied at different rates (200 μm/s to 10,000 μm/s) demonstrating remarkably little strain-rate dependence, according to one or more embodiments of the present disclosure.

FIGS. 34(a)-(b) illustrate graphical views of a single sensing cell tested with two different strain-controlled load functions: (a) showing trapezoidal load function with transient strain rate of 1000 μm/s and (b) showing ramp load function with strain rate of 200 μm/s, according to one or more embodiments of the present disclosure.

FIG. 35(a) illustrates an image of a tactile 9×9 sensing array using a cross-shaped indentation stamp, according to one or more embodiments of the present disclosure.

FIGS. 35(b)-(d) illustrates a graphical view of the measured change in capacitance in each cell of the sensing array under an indentation of 200 μm, 250 μm, and 300 μm, respectively, according to one or more embodiments of the present disclosure.

FIG. 35(e) illustrates an image of a tactile 9×9 sensing array as the sensing array conformed to a curved surface, according to one or more embodiments of the present disclosure.

FIG. 35(f) illustrates a graphical view of the measured change in capacitance in each cell of the sensing array conforming to a curved surface under an indentation of 300 μm, according to one or more embodiments of the present disclosure.

### DETAILED DESCRIPTION

Stretchable electronic tactile sensors based on a resistive sensing device were built and verified. Steady-state analysis involving multi-physics coupling was implemented on a numerical model. Routing methods were developed to provide the best trade-off between spatial resolution and extrinsic stretchability. Both resistive and capacitive sensing devices were fabricated. Also, measurement data was collected to verify each sensor's operation.

To accomplish electronic tactile sensing, stretchable electronic tactile sensors are provided that are sufficiently elastic to conform to irregularly shaped objects. For example, the stretchable electronic tactile sensors may be placed over an irregularly shaped object for the purpose of capturing tactile signals such as pressure or shear force distributions, among other things.

To accomplish soft electronic tactile sensing, stretchable electronic tactile sensors are provided that are sufficiently soft and elastic as to conform to irregularly shaped soft objects without imposing deformation on them. For example the stretchable electronic tactile sensors may be placed over the skin and be unobtrusively integrated into a medical glove. Also, the stretchable electronic tactile sensors may be placed on robotic devices that have irregular shapes. Stretchable soft electronic tactile sensing arrays may be made using soft lithography methods, by embedding flexible electrodes and liquid microchannels within an elastomeric membrane. The stretchable electronic tactile sensors can capture mechanical strain patterns during contact with an irregular object, for example, contact between a finger and a touched object, by measuring electronic changes that vary with strain in the membrane.

Sensor signals generated by the tactile sensor are processed using methods capable of separating invariant mechanical features of a touched object from motor activity during the highly variable touch interactions, such as those executed by a human. This can be achieved through analysis of softness perception and by analyzing sensed signals at multiple length scales in order to model the co-variation of pressure-dependent strain energy density with properties of a touched object.

Another use of the stretchable electronic tactile sensors is to image mechanical properties of touched objects such as, for example, tissue palpated during medical examination, in order to aid in diagnosis. In the case of tissue palpation, the sensing method is used to detect and image subcutaneous anomalies in tissue. For diagnosis of breast and prostate cancer, palpation remains the easiest, lowest cost, and least invasive method of diagnosis. However, current methods of palpation do not provide quantitative feedback that could aid diagnosis or otherwise assist in documenting examinations. Additionally, physicians often miss nodules, due to tissue inhomogeneities, perceptual limitations, or use of incorrect techniques. By introducing electronic sensing into existing practices of palpation, diagnoses may be improved. Further, by using stretchable electronic tactile sensors, new methods for assessing the clinical skill of palpation may be provided. Correct palpation requires that touch be applied in ways that depend on the tissues that are felt, with appropriate contact, pressure and exploratory movements. This is difficult to communicate, but is required for correct diagnosis. There are no established methods for quantifying the correctness of palpation. In order to improve this situation, the stretchable electronic tactile sensors may be used to collect palpation data and provide an objective assessment of palpation techniques.

For illustrative purposes, the principles of the present disclosure are described by referencing various exemplary embodiments. Although certain embodiments are specifically described herein, one of ordinary skill in the art will readily recognize that the same principles are equally applicable to, and can be employed in, other systems and methods.

Before explaining the disclosed embodiments of the present disclosure in detail, it is to be understood that the disclosure is not limited in its application to the details of any particular embodiment shown. Additionally, the terminology used herein is for the purpose of description and not limitation. Furthermore, although certain methods are described with reference to steps that are presented herein in a certain order, in many instances, these steps may be performed in any order as may be appreciated by one skilled in the art; the novel methods are therefore not limited to the particular arrangement of steps disclosed herein.

### Definitions

It is to be noted that as used herein and in the appended claims, the singular forms “a”, “an”, and “the” include plural references unless the context clearly dictates otherwise. Furthermore, the terms “a” (or “an”), “one or more” and “at least one” can be used interchangeably herein. The terms “comprising”, “including”, “having” and “constructed from” can also be used interchangeably.

The terms recited below have been defined as described below. All other terms and phrases in this disclosure shall be construed according to their ordinary meaning as understood by one of skill in the art.

As used herein, “bonding” refers to one or more of bonding, joining, fastening, affixing, attaching, securing, and fusing. A person of skill in the art would readily understand that this list is non-exhaustive and other terms not included here can be used to refer to “bonding.”

As used herein, “casting” refers to one or more of casting and pouring. A person of skill in the art would readily understand that this list is non-exhaustive and other terms not included here can be used to refer to “casting.”

As used herein, “curing” refers to cross-linking and/or vulcanization of polymer chains. A person of skill in the art would readily understand that this list is non-exhaustive and other terms not included here can be used to refer to “curing.”

As used herein, “extracting” refers to extracting, removing, pulling, drawing, and withdrawing. A person of skill in the art would readily understand that this list is non-exhaustive and other terms not included here can be used to refer to “extracting.”

As used herein, “fixing” refers to one or more of fixing, winding, tensioning, wrapping, laying, placing, positioning, putting, securing, adapting, and inserting. A person of skill in the art would readily understand that this list is non-exhaustive and other terms not included here can be used to refer to “fixing.”

As used herein, “stretchable” refers to the ability of a material, structure, device, or component of a device to be stretched, compressed, and/or elongated in one or more dimensions without undergoing a transformation that introduces significant permanent deformation, such as irreversible strain or strain characterizing the failure point of the material, structure, device, or component of a device. As used herein, “stretchable” refers to the ability of a material, structure, device or device component to be stretched, compressed and/or elongated in at least one dimension without undergoing a transformation that introduces significant permanent deformation, such as irreversible strain or strain characterizing the failure point of the material, structure, device or device component. In an exemplary embodiment, a stretchable material, structure, device or device component may undergo stretching in at least one dimension without introducing permanent deformation larger than or equal to about 5%, preferably for some applications without introducing permanent deformation larger than or equal to about 1%, and more preferably for some applications without introducing permanent deformation larger than or equal to about 0.5%. In an exemplary embodiment, a stretchable material, structure, device or device component may be stretched in at least one axial dimension by about 1% or more, 10% or more, 50% or more, 100% or more, or 200% or more. Generally, “highly stretchable” is meant to imply a stretchable material, structure, device or device component that may be stretched in at least one axial dimension by more than 100%.

As used herein, “tactile information” refers to information acquired by touching. “tactile information” can include, but is not limited to, temperature, humidity, normal force distributions (pressure), shear force distributions (traction), softness, shape, and texture.

Tactile sensing can include the electronic sensing of mechanical stimuli felt during active touch perception of objects through physical contact, similar to human touch. By designing the electronic structure and material properties of these sensors, and by processing the resulting signals appropriately, it is possible to capture the mechanical and geometric features of a touched object. This can be achieved while ensuring that the intrinsic haptic (touch) perceptual abilities of a wearer are preserved.

Two categories of sensing arrays based on different working principles are discussed below, resistive sensors and capacitive sensors. Stretchable electronic tactile sensors may be constructed based on resistive sensing, capacitive sensing or both. The basic idea of resistive sensing is to relate the change in resistance of a stretchable electrical conductor to an externally applied load, i.e. surface pressure, strain. External load can be deduced based on measurements of resistance. With respect to capacitive sensing, instead of measuring the resistance of an electrical conductor, capacitive sensing measures the capacitance change of a stretchable capacitor and then calculates the corresponding external load.

The operating principles of resistive and capacitive sensing are discussed below. Analytical models for the two types of sensors are discussed as well.

Resistive sensors can be categorized into two basic families: strain sensors and pressure sensors, depending on the final output signal. However, the principle governing these transducers is the same. Each of these transducers is built on the law of resistance. The basic model for a resistive sensor employing a stretchable electrical conductor is a single channel embedded in a stretchable substrate. Combined with all used materials' mechanical properties and device geometry, analytical equations directly calculating the resistance of a given geometry resistor under known strain or pressure can be established.

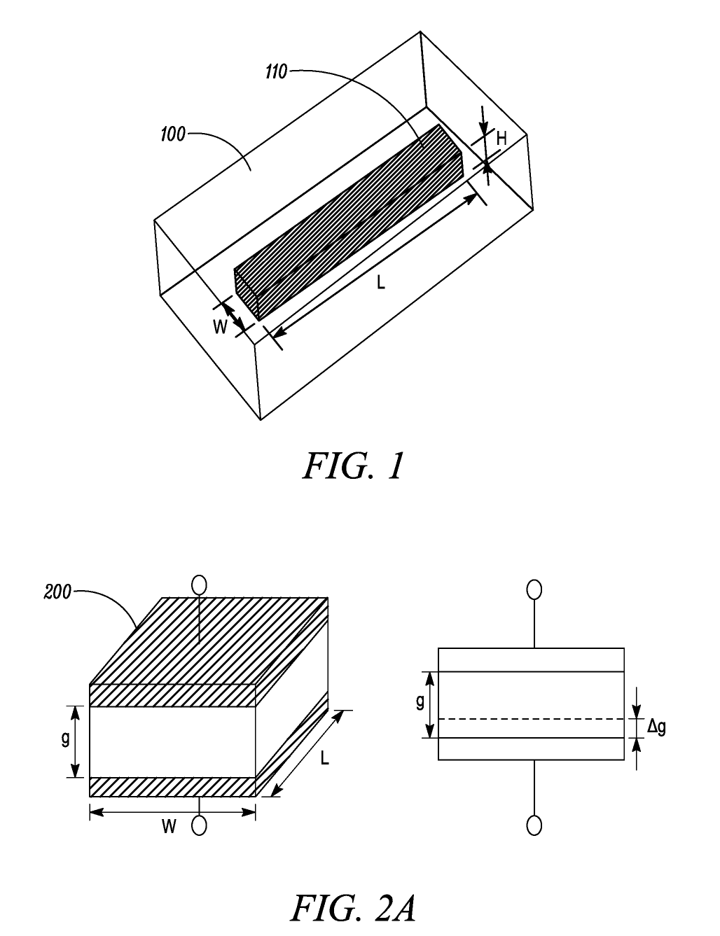

As shown in FIG. 1, embedded in the middle of the substrate 100 is a channel 110 with a rectangular cross-section that is filled with conductive fluid. External load can be introduced to the sensor by stretching along the axis of the channel 110 or pressing on the top surface of the sensor. Assuming the channel 110 has a uniform cross-section, and the conductive liquid has a uniform resistivity, then the overall electrical resistance, the longitudinal length of the channel 110, and the cross-section of the channel 110 can be related as:

$${R}_{0} = ρ \frac{L}{wh}$$

where R₀ is the resistance between the two terminal faces, and L, w and h are the length, cross-sectional width and height of the conductive channel 110, respectively.

Under an external load such as a positive strain along the axial direction of the channel 110, the overall length of the channel 110 will increase, while the cross-sectional area of the channel 110 will decrease, hence the resistance will be increased, The new resistance R can be described as follows:

$$R = ρ \frac{( L + Δ L )}{( w + Δ w ) ( h + Δ h )}$$

where ΔL, Δw and Δh are the changes in the dimensional sizes of channel 110. The engineering strain ε can be employed here to simplify the equation:

$$ɛ = \frac{Δ L}{L}$$

In highly stretchable substrates, such as silicone rubber, it is reasonable to assume that the substrate material is linear elastic and isotropic. Hence combined with Poisson's ratio v, Δw and Δh can be replaced by −vεw and −vεh giving the following equation:

$$Δ R = R - {R}_{0} = \frac{ρ L}{wh} \{ \frac{( 1 + 2 v ) ɛ - {v}^{2} {ɛ}^{2}}{{( 1 - v ɛ )}^{2}} \}$$

For an elastomeric material, the Poisson's ratio can be approximated as v=0.5, providing the equation:

$$Δ R = \frac{ρɛ L ( 8 - ɛ )}{{wh ( 2 - ɛ )}^{2}}$$

This equation shows the direct analytical relationship between strain and resistance change in a channel conductor with a rectangular cross-sectional shape. Based on this equation, a strain sensor can be designed. For a resistive pressure sensor, the relationship between contact pressure p and change of resistance (ΔR) can be determined by using linear elastic fracture mechanics (LEFM). Assuming that the cross-section of the channel 110 remains rectangular upon deformation, the change of resistance can be written as:

$$Δ R = \frac{ρ L}{wh} \{ \frac{1}{1 - 2 ( 1 - {v}^{2} ) \frac{wp}{Eh}} - 1 \}$$

where E is the Young's modulus of the substrate material and p is the contact pressure. A resistive pressure sensor can be made based on the above equation.

Capacitive sensing is a method that uses capacitive sensors for tactile sensing based on the principle that the capacitance of a capacitor is a function of its geometric dimensional size and the relative permittivity of a dielectric located between two plate electrodes. Capacitive sensors can be divided into strain sensors and pressure sensors, depending on the device design and the interpretation of the device output.

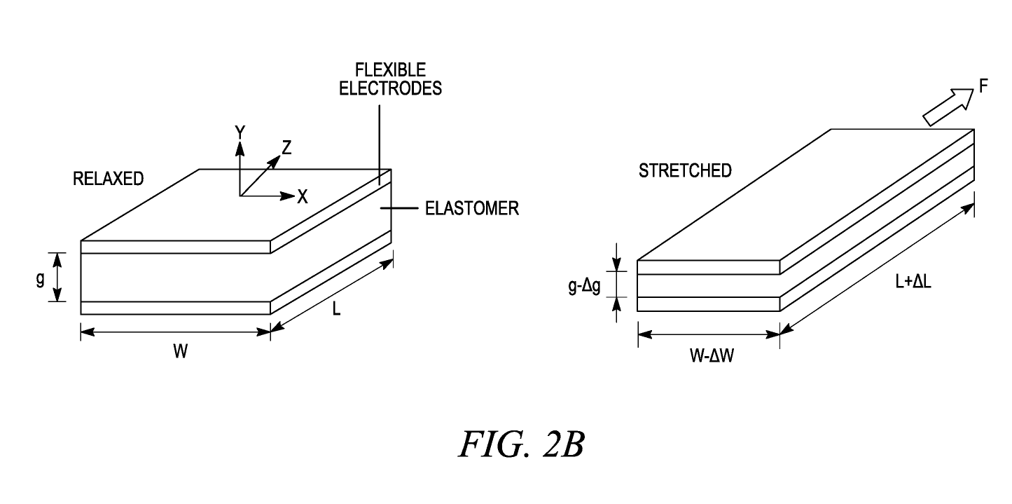

A capacitive sensor 200 based-on a rigid plate capacitor is illustrated in FIG. 2A. The lateral size of the capacitive sensor 200 cannot be changed, only the thickness g of the dielectric can be changed. Each microchannel functions as an electrode, forming a capacitor with every orthogonal microchannel in the opposing layer.

The relationship between change of capacitance and vertical strain for devices made using, for example, lithographic methods, can be written as:

$$Δ C = {e}_{0} {e}_{r} A ( \frac{1}{g - Δ g} - \frac{1}{g} )$$

When Δg is small enough, this formula can be simplified using approximation by Taylor expansion:

$$Δ C \approx \frac{{e}_{0} {e}_{r} A}{g} [ \frac{Δ g}{g} - \frac{Δ {g}^{2}}{{g}^{2}} ]$$

$$Δ C \approx {C}_{0} ( e - {e}^{2} )$$

where ε is defined as the engineering strain by ε=Δg/g. From the above equation, the relationship between the change of capacitance and strain is linear when the strain is very small comparing to the original thickness g. As strain increases, the nonlinear behavior will became significant as a result of the the 2nd order component ε².

For stretchable capacitive sensing, both electrodes and dielectric materials need to be stretchable. Hence the material's Poisson's ratio needs to be taken into consideration. As shown in FIG. 2B, under lateral strain load, the capacitor sensor 200 experiences changes in dimension along all three Cartesian coordinates. Assuming all of the material is isotropic, the deformation is in the range of a linear zone and small enough for use of an engineering strain definition. Thus, the relationship between capacitance C and lateral strain can be written as:

$$C = {e}_{0} {e}_{r} [ \frac{( w + Δ w ) ) ( L + Δ L ) )}{( g + Δ g ) )} ]$$

where e0 and eᵣ are the free space permittivity and the relative permittivity of the dielectric, respectively. Substitute Δw=−vεw, ΔL=εL, and Δg=−vεg into the equation to obtain the following:

$$C = {e}_{0} {e}_{r} [ \frac{w ( 1 - v {ɛ}_{s} ) ) L ( 1 + {ɛ}_{z} ) )}{g ( 1 - {vɛ}_{z} ) )} ] - {e}_{0} {e}_{r} ( 1 + {ɛ}_{z} ) \frac{wL}{g} = {C}_{0} ( 1 + {ɛ}_{s} )$$

Hence the change of capacitance can be represented by:

ΔC=ε_{z}C₀

where v is the Poisson ratio of the dielectric (assuming the electrodes can be stretched to the same length as the dielectric), and ε_{z} is the lateral strain.

In some embodiments, the operating principle of the tactile sensors of the present invention is mutual capacitance. Mutual capacitance sensing is based on a change in capacitance between two electrodes accompanying a change in geometric configuration or the proximity of dielectric materials in the vicinity of the two electrodes. When pressure is applied to a compliance capacitance sensor, the distance between the electrodes is reduced, yielding an increase in capacitance, assuming other factors, such are electrode geometry, remain unchanged. Tactile sensing arrays based on mutual capacitance can often be formed through the arrangement of parallel electrodes in orthogonal directions on two layers. The tactile sensors of the present invention can contain electrodes embedded in a highly elastic substrate, such that a surface pressure applied to the device elicits a strain that reduces the inter-electrode distance, increasing mutual capacitance between the electrodes.

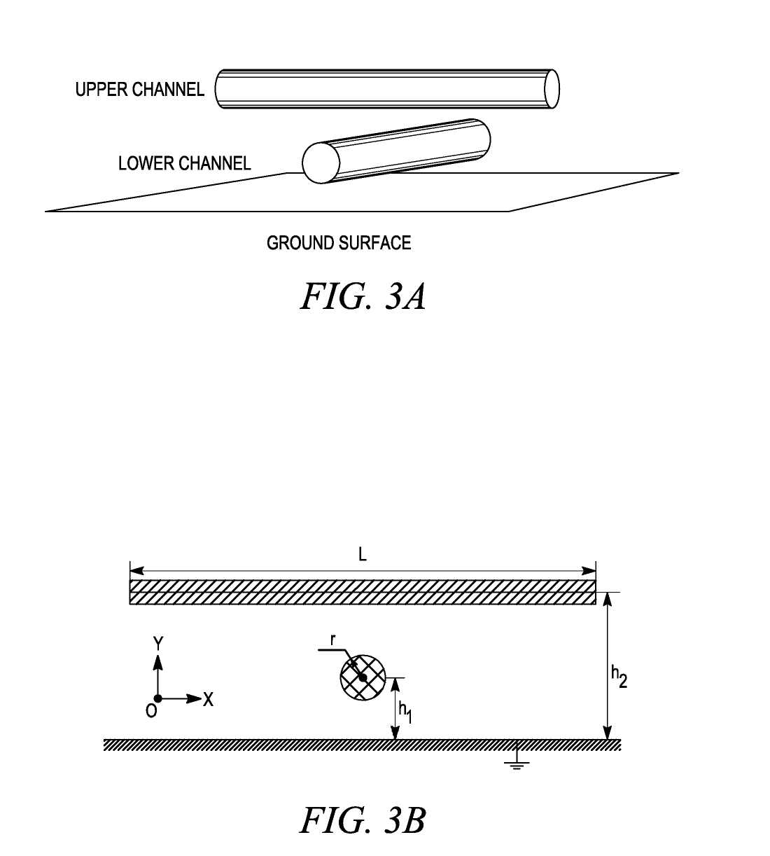

Using electromagnetic transmission line coupling theory and solid mechanics, an analytical model for the strain-induced change in mutual capacitance between orthogonal channel pairs fabricated using the direct filament casting method of Example 1 was developed. The dominant effect was found to be due to bulk compression of the sample, which yielded an increase in capacitance due to a reduction in inter-channel distance. The effective mutual capacitance between an electrode pair can be expressed as:

$${C}_{eff} = \frac{2 πɛ}{log [ {h}_{2} / r + \sqrt{{( {h}_{2} / r )}^{2} - 1} ]} {\int }_{0}^{L / 2} \frac{log [ \frac{{x}^{2} + {( {h}_{2} + {h}_{1} )}^{2}}{{x}^{2} + {( {h}_{2} - {h}_{1} )}^{2}} ]}{log [ \frac{4 {h}_{1}^{2}}{{r}^{2}} ] - log [ \frac{{x}^{2} + {( {h}_{2} + {h}_{1} )}^{2}}{{x}^{2} + {( {h}_{2} - {h}_{1} )}^{2}} ]} dx \qquad ( 1 )$$

where L is the length of the conductive channel, h₁ and h₂ are the respective distances between the channels and the ground surface, r is the channel radius, and c is the material permittivity. A ground surface at the base of the sensor mimics the measurement configuration. This model of the mutual capacitance between the two orthogonal conductive channels is depicted in FIGS. 3A-3B.

Compressing the sample yields an engineering strain c that decreases the vertical displacement between electrodes, so that h′ᵢ=hᵢ (1−ε), for i=1, 2. By substituting this relation in equation (1), the extent of change in C_{eff} with strain ε can be predicted. Continuum mechanics dictates that the electrode shape also deforms when subjected to an applied stress; this would also affect capacitance, but the correction can be shown to be suppressed by a factor (r/h₂)², and thus this parameter can be neglected in the model. In the large strain limit (ε→1), Equation (1) predicts a quadratic change in capacitance with strain, C_{eff}=C₀+αε², where α is a geometry-dependent constant.

The Finite Elemental Method (FEM) is a numerical method for modeling and solving problems, such as herein where resistive tactile sensing, solid mechanics, solid-fluid interaction and AC/DC electrics are involved.

A simulation modeling process carried out with the FEM method using a computer program involves three main components. First, coupling techniques between different physical components can be summarized as the mutual coupling between solid structural mechanics and the filled compressible fluid. Secondly, surface pressure on solid interfaces will be identical at all boundary points on the interface, assuming the fluid is homogeneous. Third, the initial pressure is assumed to be the same as standard atmosphere pressure, which makes sense if the fluid is filled under standard atmospheric circumstances.

The solid-fluid interface pressure is calculated based on relationships between volume and pressure in the compressible fluid. The calculated results are used as interface boundary conditions for the next iteration. Iterations keep going until a stable balance is achieved with a mathematical convergence of values.

Second, mutual coupling between solid structural mechanics and the filled incompressible fluid is determined. Other than using iterative solving methods, a direct solving method may be applied in this coupling technique for an incompressible fluid. In the case of an incompressible fluid the overall volume of the fluid remains constant regardless of how much load is applied to the interface between the fluid and any other solid structure. Taking this constraint as one extra independent equation, the solid-fluid interface pressure can be treated as an extra, unknown variable. By doing this, depending on the load applied on the outside surface, the corresponding solid-fluid interface pressure may be determined based on the condition that the deformed channel still has the same volume as the un-deformed channel. The volume can either be calculated directly using volume integration or Gaussian theorem boundary surface integration, but the latter method does not work in 3D simulations. Also, the Gaussian theorem boundary surface integration works in 2D without using moving mesh coupling techniques.

Third, single direction coupling from solid structure mechanics to electrical analysis may be determined. The final deformation of the channel is calculated by a coupling model of solid and fluid interactions by using a moving mesh component in the FEM software program to update the deformed new mesh into the electrical physics component for electrical analysis. The deformation variables (u,v,w) are used to define the new mesh based on the original un-deformed mesh.

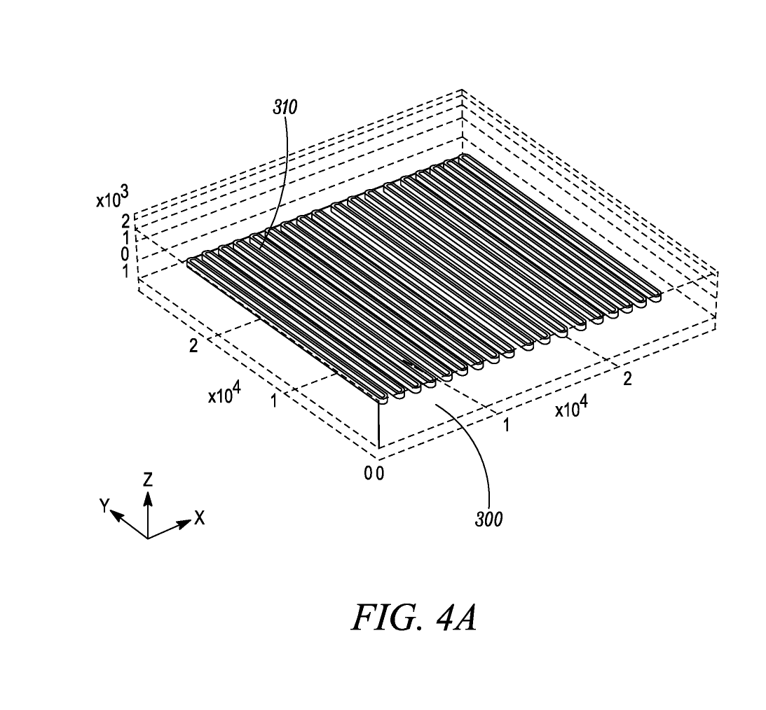

Based on the techniques discussed above, a 3D model with a small channel 310 embedded in the soft substrate 300 was created and is shown in FIGS. 4A and 4B. As shown in FIGS. 4A and 4B, the channel cross-sectional size is 200 μm (width)×300 μm (height). The overall size of the sensor is 25 mm×25 mm. The simulation employed platinum-cured silicone rubber (Ecoflex oo-30,Smooth-on, Inc.) for the substrate 300, and 2 wt. % saline solution as the conductive fluid filling the channel 310. All of the material properties used in the simulation are listed in table 1 below:

TABLE 1
Properties of Materials Used in Simulation

| | Young's | Poisson's | | Electrical | Relative |
|---|---|---|---|---|---|
| Parameter | Modulus | Ratio | Density | Conductivity | Permittivity |
| Value | 6 × 10⁴ Pa | 0.5 | 1070 | 3 S/m | 1 |
| | | | kg/m³ | | |

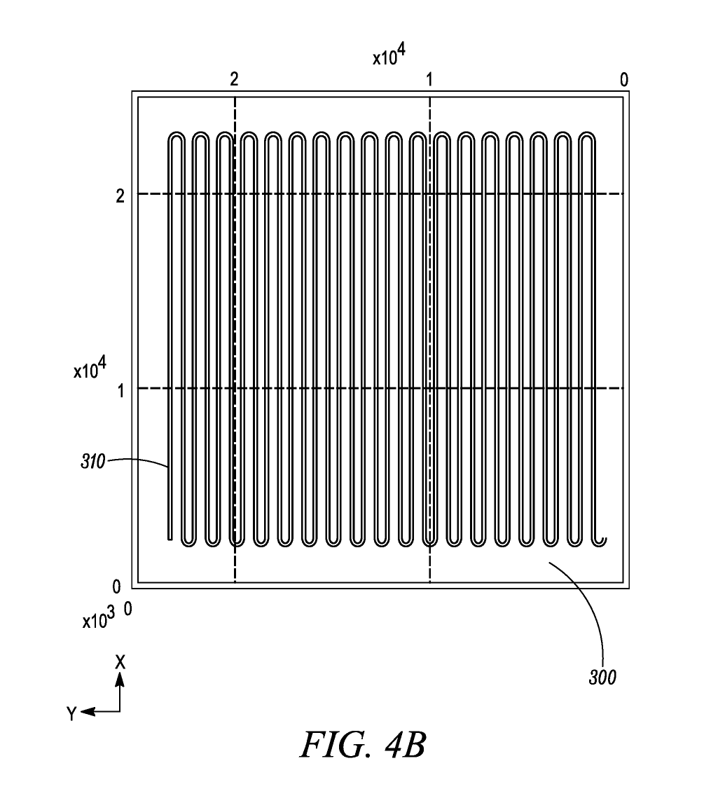

Under a pressure of 30 Pa on the top surface, with the bottom surface fixed while all the other walls are free surfaces, the deformation of a final stable state is solved and shown in FIGS. 5A-5D, wherein FIG. 5A shows a solution with the deformation due to a pressure of 0 Pa, FIG. 5B shows a solution with the deformation due to a pressure of 30 Pa, FIG. 5C shows a side view of the channel deformation due to a pressure of 0 Pa, and FIG. 5D shows a top view of channel deformation due to a pressure of 0 Pa. Sweeping through the applied pressure from 0 Pa to 60 Pa, the resistance versus applied pressure can be plotted.

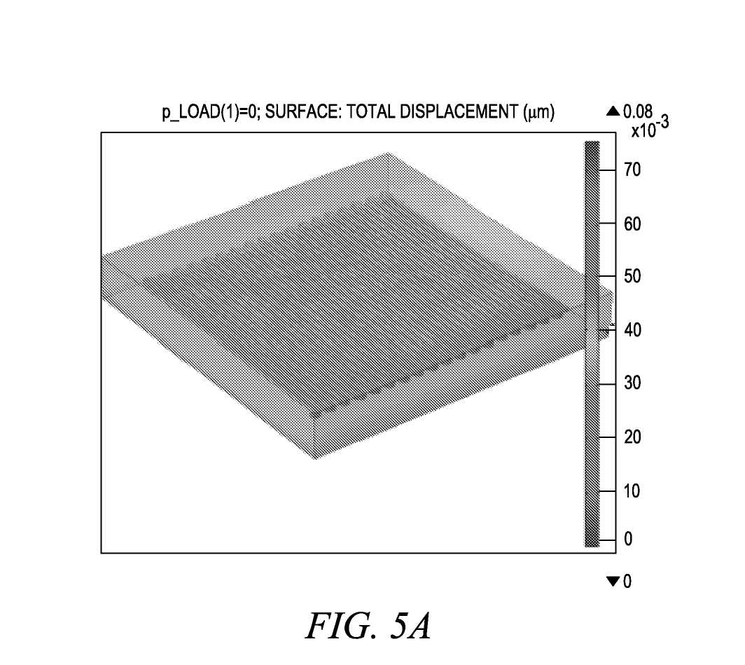

From the chart shown in FIG. 6, the relationship has a very good linearity in the range of pressure up to 60 Pa, which is different from the analytical solution derived via linear elastic fracture mechanics (LEFM). The main reason for this disagreement may be due to the fact that the incompressible fluid interaction has been taken into consideration in the calculation.

In array network devices, three basic types of addressing methods have been employed in the semiconductor electronic industry: passive matrix addressing, active matrix addressing and independent cumulative addressing. Independent cumulative addressing needs two separate electrical routines for each single element sensor, which requires twice the amount of routines as the amount of elements. This makes it impractical for constructing a sensing array of large dimensions.

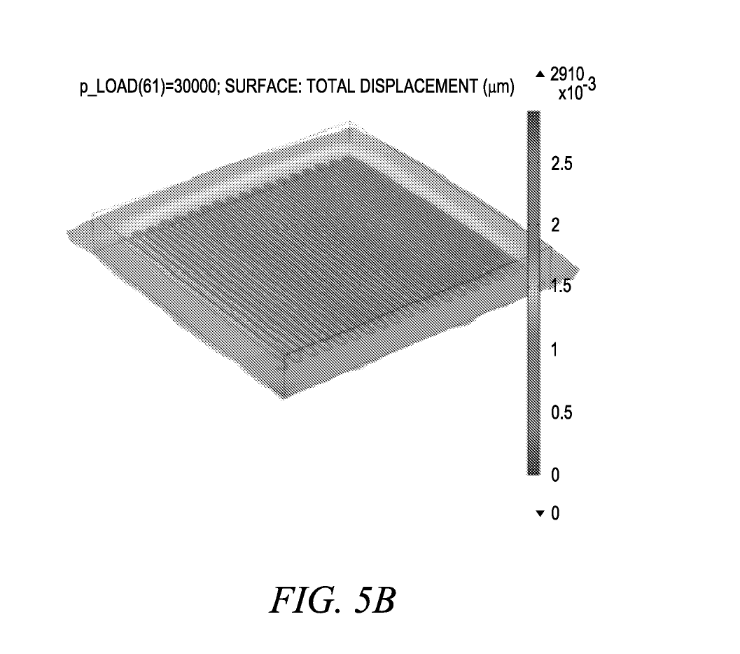

Active matrix addressing has been employed in most modern flat-panel display devices and is based on thin-film transistor (TFT) technology that can be cascaded with the element device. As shown in FIG. 7, each TFT can be switched on or off by a set of column-shared scanning routines, making the corresponding element addressable or not. Active matrix addressing has the advantages of minimizing signal crosstalk and faster reading rates. However, passive matrix addressing is relatively easier for fabrication.

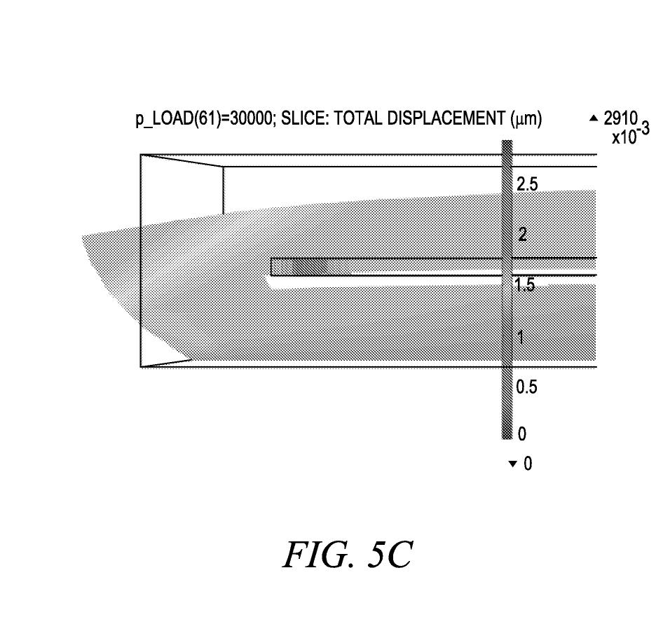

As shown in FIG. 8, passive addressing consists of two sets of addressing wires, X and Y, which intercross with each other. By selecting any pair of (Xᵢ,Yᵢ), one and only one element will be selected for reading. The passive matrix addressing method shown in FIG. 8 has been used to fabricate a 4-element resistive sensing array of stretchable electronic tactile sensors, which is discussed below. For a capacitive sensing array, the electrical routing wires are serving as both capacitor electrodes and for electrical routing at the same time. The passive addressing method has also been employed for capacitive sensing, combined with the design of geometric patterns that yield high stretchability.

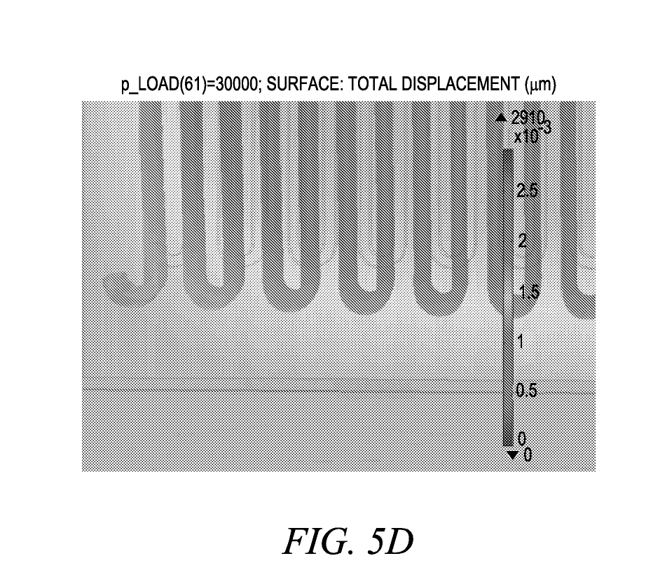

As shown in FIGS. 9A-9C, three pattern designs of different spatial resolution are shown. In FIG. 9A, all capacitors are located at the perpendicular crossing points, meaning they all have close capacitance values. Inside the area of the black rectangle, there are 4 capacitors. While in FIGS. 9B and 9C the spatial resolution is increased twofold in one or both axial directions. There is also a different capacitor geometric configuration in FIGS. 9B and 9C compared to that of FIG. 9A. These different capacitors are formed between parts of the routine that almost overlap with each other in parallel. This difference in capacitor geometry will result in differences in the capacitance value. While the patterns shown in FIGS. 9A-9C are discussed with respect to the capacitors, it should be understood that the patterns shown for the capacitive stretchable electronic tactile sensors may also be used with resistive sensors, including those that employ stretchable electronic tactile sensors that have microfluidic channels filled with conductive fluid.

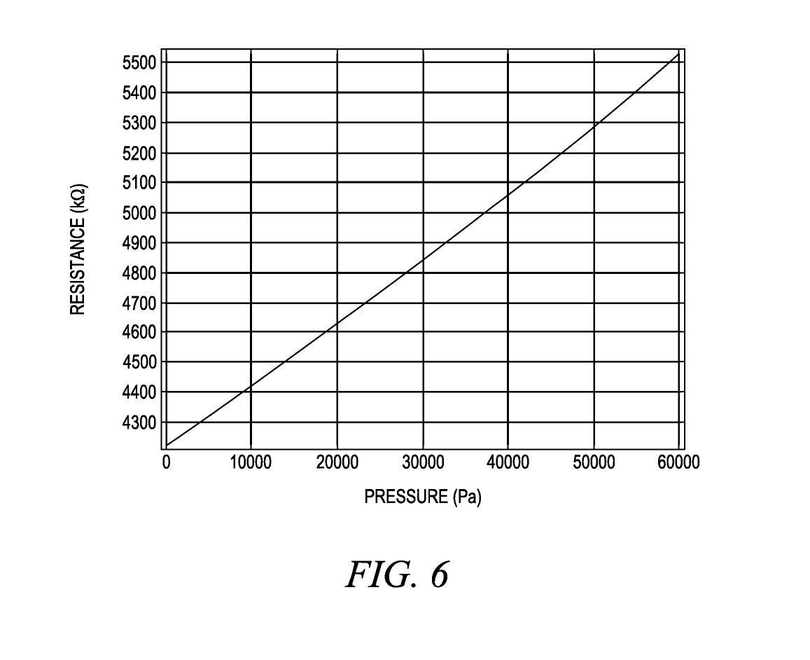

Two other types of optimized patterns are shown in FIGS. 10A and 10B. In these patterns, all of the capacitors have close capacitance values. They are all formed at the relatively parallel parts of the routings in two layers. This provides a larger capacitance than those formed by perpendicular overlap, making it less difficult for measurement. Another advantage of these designs is that a higher spatial resolution can be achieved. Choosing one cell marked by the black rectangle, four capacitors are formed in FIG. 10A, and nine capacitors are formed in FIG. 10B. The spatial resolution of the design shown in FIG. 10A is two times higher than that for the design shown in FIG. 10B. While the patterns shown in FIGS. 10A and 10B are discussed with respect to capacitors, it should be understood that these patterns for the stretchable electronic tactile sensors may also be used with resistive sensors, including stretchable electronic tactile sensors that have microfluidic channels filled with conductive fluid.

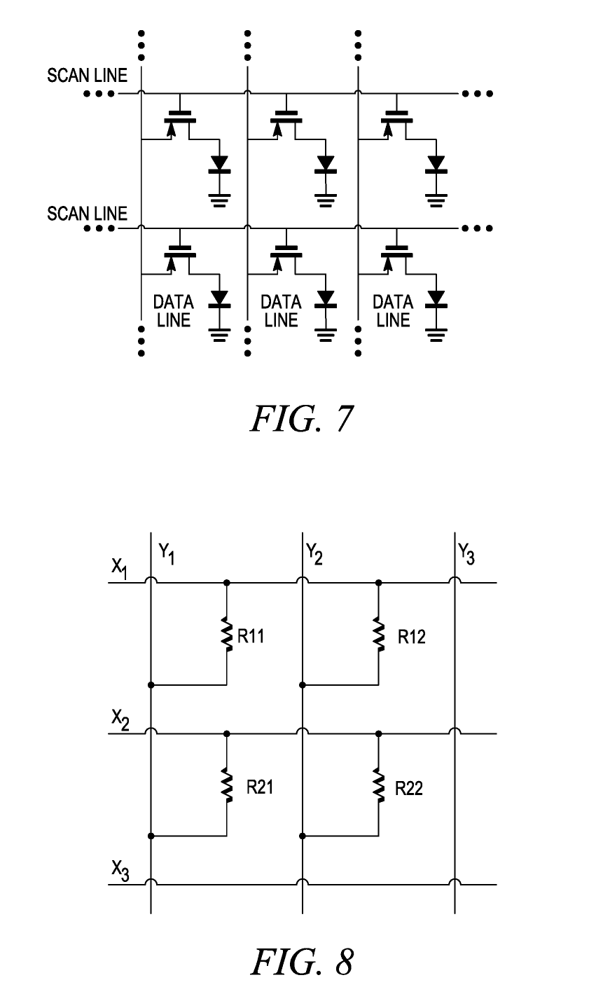

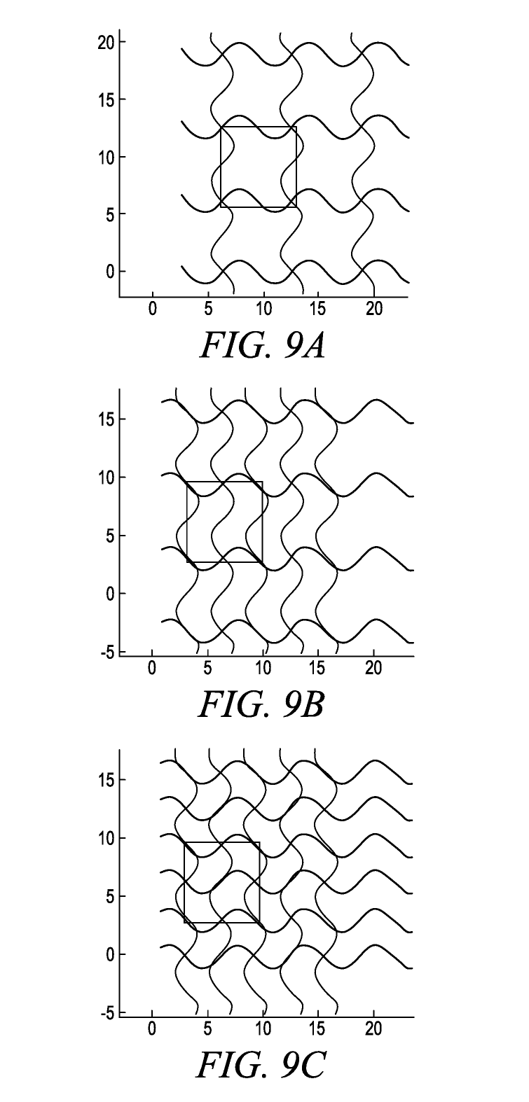

FIGS. 11A-11G and 12 additionally show a variety of patterns that may be used in the construction of arrays of stretchable electronic tactile sensors. The patterns shown in FIGS. 11-12 may be used with either capacitive or resistive sensors, including stretchable electronic tactile sensors that have microfluidic channels filled with conductive fluid.

The fabrication of resistive and capacitive sensing arrays of stretchable electronic tactile sensors is discussed below. As part of the fabrication process, the 3D printed mold and the casted devices are inspected with an optical microscope and a fluorescence confocal microscope to determine the presence of flaws.

As the substrate material elastic substrates that are stretchable and electrically insulating may be used. For example, stretchable, electrically insulating elastomers may be employed. Such materials may have a Shore hardness from a stiffer Shore A of 90 to a softer Shore 00 of 10. Example materials include, but are not limited to, silicone rubbers and urethane rubbers. The dielectric strength of such materials should be greater than 4,000,000 V/m or, more preferably, greater than 13,000,000 V/m. On exemplary material has a dielectric strength of 13,779,5000 V/m.

As the electrically conductive material may be used a eutectic alloy, a conductive polymer, a conductive gel or paste, an ionic solution or conductive thread. Preferred eutectic alloys are eutectics at 20° C. An exemplary ionic solution is glycerine saline solution. Exemplary conductive threads include silver coated polymer thread and steel fiber thread. The conductive material should have a conductivity of at least 10 S/m, or at least 24 S/m or at least 30,000 S/m or at least 33,000 S/m. Another exemplary electrically conductive material is poly(3,4-ethylenedioxythiophene) polystyrene sulfonate (PEDOT:PSS) which may be fabricated to have a conductivity of from 10 to about 1000 S/m. For resistive sensors the electrically conductive materials should have an electrical conductivity of from 10-1,000,000 S/m or from 24-33,000 S/m.

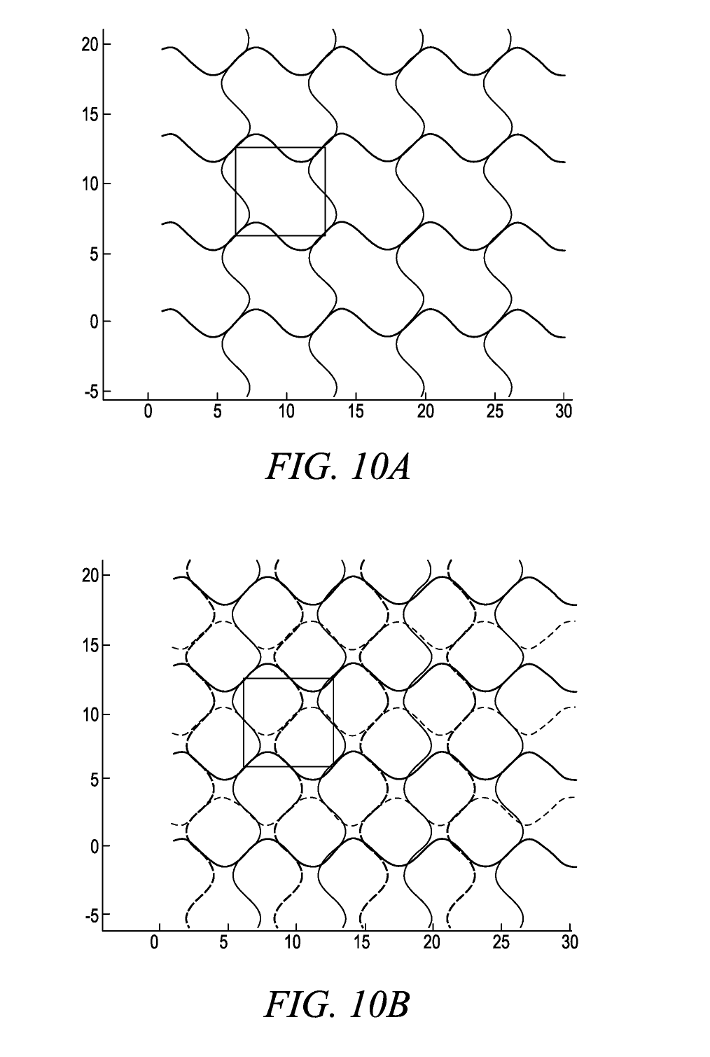

In an embodiment of the present invention, in fabricating stretchable electronic tactile sensors, platinum-cured silicone rubber (Ecoflex oo-30, Smooth-on, Inc.) is used. This material is very soft with a hardness in the OO scale below 30. It is very stable after curing and small feature sizes as low as a few micron-meters can be fabricated in this manner. Referring to FIG. 13, the procedure starts with printing a 3D casting mold on a 3D printer. After cleaning of the mold, the mold is cast with premixed silicon rubber and the whole sample is degassed under pressure of (e.g., 29 mmHg). After the curing process, the cast rubber is removed from the mold and is ready for the sealing process. A blank silicone rubber layer is prepared by either casting or spin coating on a flat surface. Before the blank layer is fully cured, the two layers are combined together with the open channel facing the blank layer. After the second curing step, conductive fluid is injected into the channel with syringes at the terminals. The final step involves insertion of electrodes into the two terminals and sealing with silicone rubber or silicone rubber glue to prevent leakage. This process creates a stretchable electronic tactile sensor.

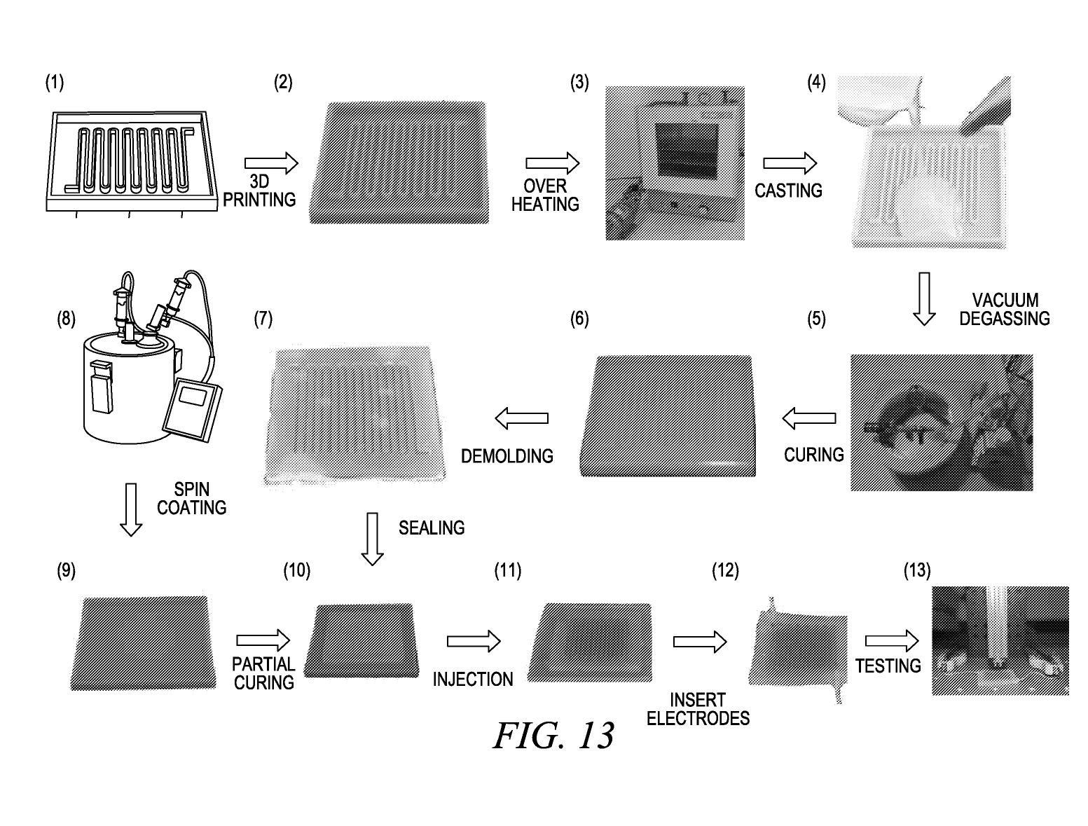

Referring to FIGS. 14A-14D, shown are stretchable electronic tactile sensors 1300. The stretchable electronic tactile sensors 1300 are resistive sensors fabricated using the procedure shown in FIG. 13. The stretchable electronic tactile sensor 1300 comprises a substrate 1310, channels 1315, channel terminal electrodes 1320 and conductive fluid 1325 that is used to fill the channels 1315. Connectors 1330 are connected to the channel end electrodes 1320. By using conductive fluid to form the stretchable electronic tactile sensors an advantage is obtained due to the increased flexibility such material provides while still being able to provide the functionality of tactile sensing. This permits the stretchable electronic tactile sensors to be used in arrays that have a high stretchability thus increasing the capability of the stretchable electronic tactile sensors to be placed on irregularly shaped objects. Furthermore, the conductive fluid provides increased stretchability in that the fluid will fill the channels regardless of their shape. As a result, the conductive fluid can conform to any arbitrary shape of the conductive channel. Also, the conductive fluid is able to conform to soft tissue without imposing artifacts. The use of conductive fluid makes it possible to control the design of the three-dimensional geometry of an electronic strain sensor or capacitive electrode, thereby optimizing electrical performance. The use of conductive fluid also permits the ability to incorporate deformation of the electrode into the design, thereby improving sensitivity.

Different conductive fluids 1325 have been filled into the channels 1315 for testing. The conductive fluids 1325 used were eutectic Gallium Indium (EGaIn) having a viscosity of 1.00×10⁻³ Pa-s and a conductivity of 33,000 S/m, saturated and low concentration saline solutions having a conductivity of at least 24 S/m, and 99.9% glycerine saline solution. These conductive fluids 1325 showed different mechanical, electrical properties, which have a significant influence on the injection and sealing procedure, as well as the stability and final performance of the stretchable electronic tactile sensors 1300. The EGaIn provides a very low resistance in the range of a few ohm, due to its high conductivity. However, EGaIn may not the best option for biomedical applications. Saline solution is cheap and acceptable for biomedical applications, and its conductivity can be tuned by changing the concentration of salt. The conductivity of saline solutions is much less than that of EGaIn.

Work has been done to miniaturize the resistive stretchable electronic tactile sensors 1300 to allow construction of a passively addressable sensing array.

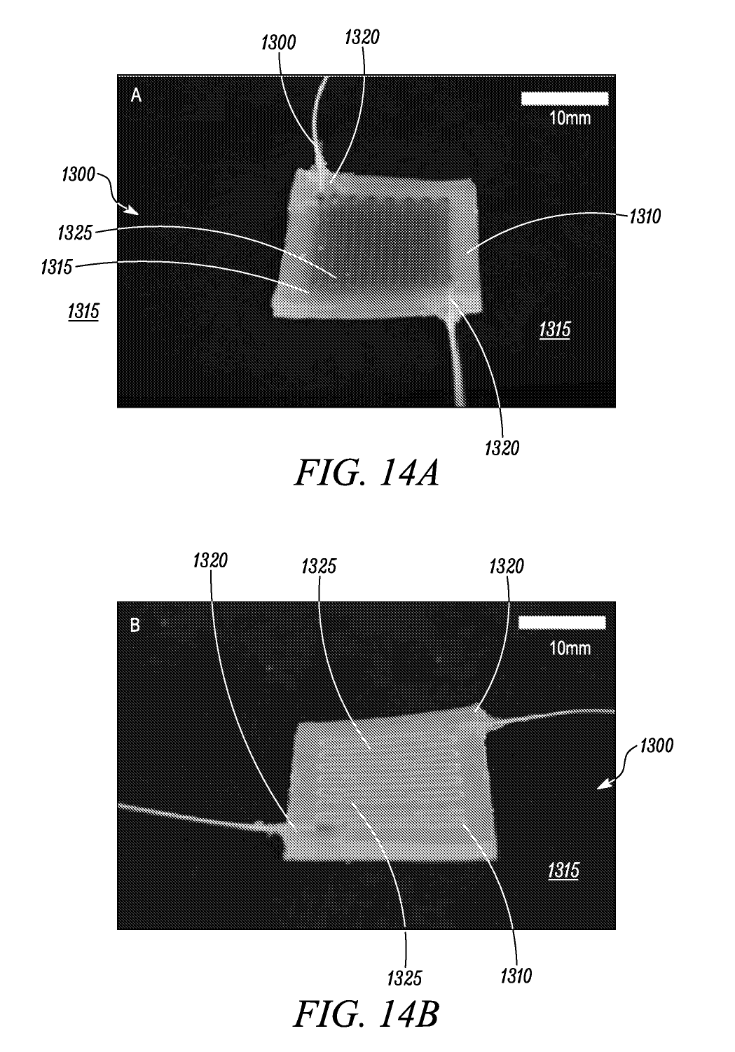

Conductive thread has also been used in wearable electronics. However most uses involve placing the conductive thread in textiles. Conductive thread may be used with solid rubber for fabricating stretchable electronic tactile sensors. Conductive thread is cheap and easy to handle in fabrication, however it is not stretchable. To provide stretchability, a pre-straining method is applied. This is shown in FIG. 15. The pre-straining method will be discussed in the following section. Capacitive sensors have been fabricated using this method.

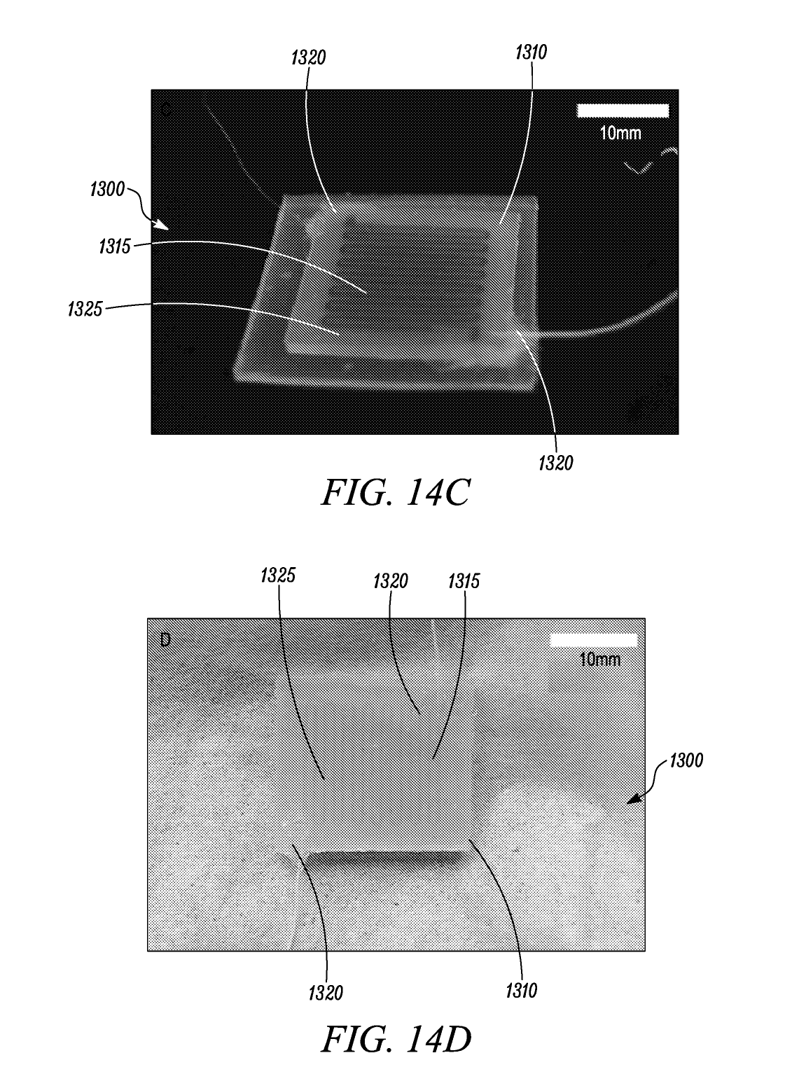

A few different electrode materials and capacitor array pattern designs have been implemented to form stretchable electronic tactile sensors 1500a-1500d in accordance with the embodiments shown in FIGS. 16A-16D. As shown in FIGS. 16A-16D, conductive threads 1520 were used as the electrode material and connectors. The conductive threads 1520 were fabricated into various shapes, such as the serpentine shape shown in FIG. 16A. The conductive thread 1520 was embedded in two parallel planes inside the substrate 1510.

In FIG. 16A the serpentine pattern of the stretchable electronic tactile sensors 1500a of conductive thread 1520 provides stretchability that is proportionally inverse to the spatial resolution. However, a reading average method can be used to double the spatial resolution while maintaining the stretchability the same, as shown in FIG. 16B. In this design, some pairs of perpendicular conductive thread 1520 have only one overlapping crossing capacitor, which is the normal case in FIG. 16A, while other pairs have three overlapping crossing capacitors. Two of the crossing capacitors are point symmetric with respect to the one in the middle. By averaging the three capacitor readings, the capacitance can be assigned to the position of the middle capacitor.

FIG. 16C shows another strategy of achieving stretchability, which is the pre-strain method mentioned in the former section. The conductive threads are stretched in the casting mold for casting. After curing of the rubber, the rubber is stretched primarily for the purpose of separating the conductive thread 1520 and the rubber substrate 1510. Then, the stretching force is gently released to let the silicon rubber contract. During this contracting procedure, due to the softness of the rubber and the friction force between the rubber inner wall and the thread, the silicon rubber will force the thread to form a helical coil pattern inside the rubber along the thread's original path. This method employs the same strategy as the serpentine shape design, but it is in 3D space, which means that much higher stretchability to spatial resolution ratio can be achieved.

FIG. 16D shows the feasibility of having stretchable electronic tactile sensors 1500d formed by using a filament of 100 μm radius to fabricate microchannel 1515 without using a sealing layer. EGaIn as a conductive fluid 1525 was filled into a channel 1515. The channel may have a radius of about 100 μm. However it should be understood that the channel may have a radius between 1-1000 μm, 1-500 μm, or 20-200 μm, or 30-120 μm.

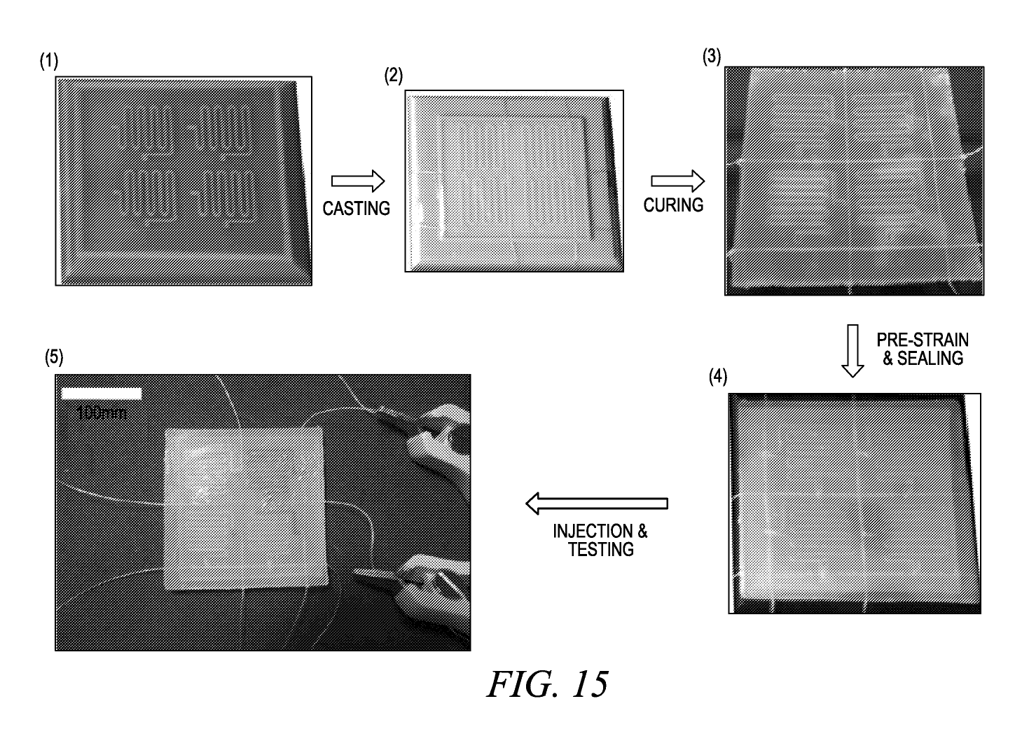

FIGS. 17A-17D show the surface morphology of a cast silicone rubber channel and 3D printed casting mold for resistive tactile sensor captured by optical microscope and a fluorescence confocal microscope. Information revealed by this analysis directly supports the feasibility of using silicone rubber, 3D printing and casting methods to fabricate the stretchable sensor

From the photos in FIG. 17A, it can be seen that the rubber channel has a lot of small indentations with diameters of less than 1μ m, which result from the 3D printed casting mold as shown in FIG. 17D, rather than trapped air bubbles. In the middle of the rubber channel it is much smoother because the mold shown in FIG. 17D is smoother as well. These characterizations illustrate that the silicone rubber is able to reflect very small details from the mold, making it a good candidate for future miniaturization of the sensor.

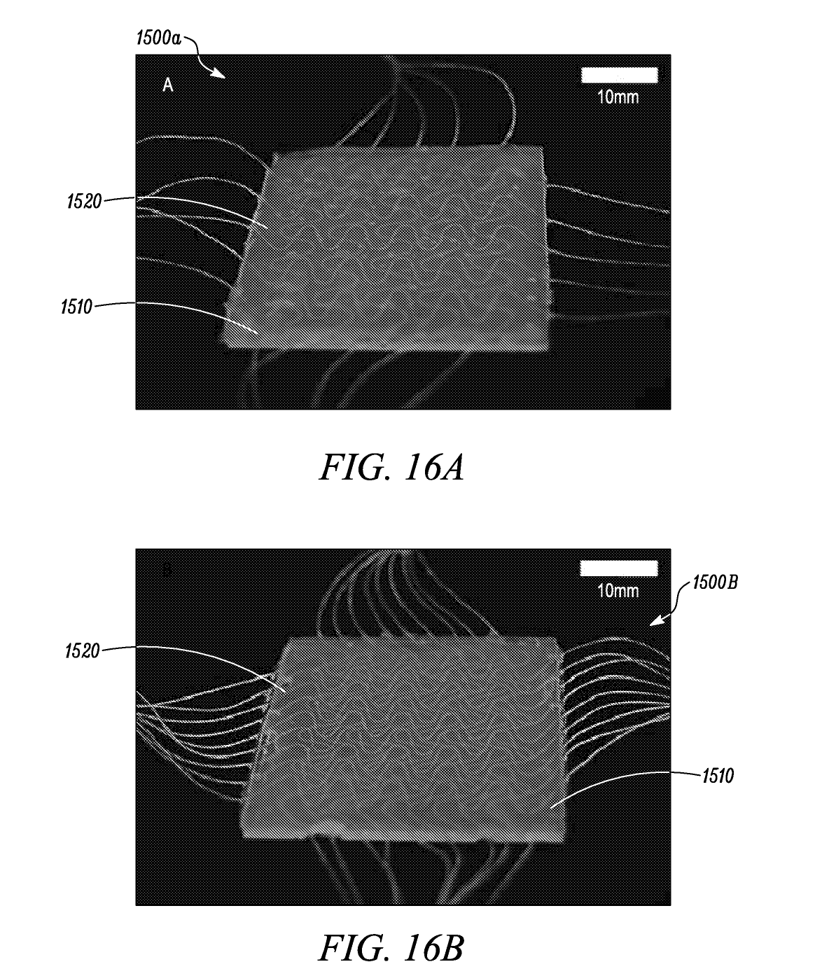

Since it is very difficult to check the curved surface using an optical microscope, a fluorescence confocal microscope was utilized to give a 3D view of the channel and mold morphology. Shown in FIGS. 18A and 18B are 3D views of the rubber channel filled with a fluorescent fluid. FIGS. 18C and 18D show the outer profile of the mold by imaging the cross-section and the curved part, from which it can be seen that the side-wall and top of the channel mold are very smooth.

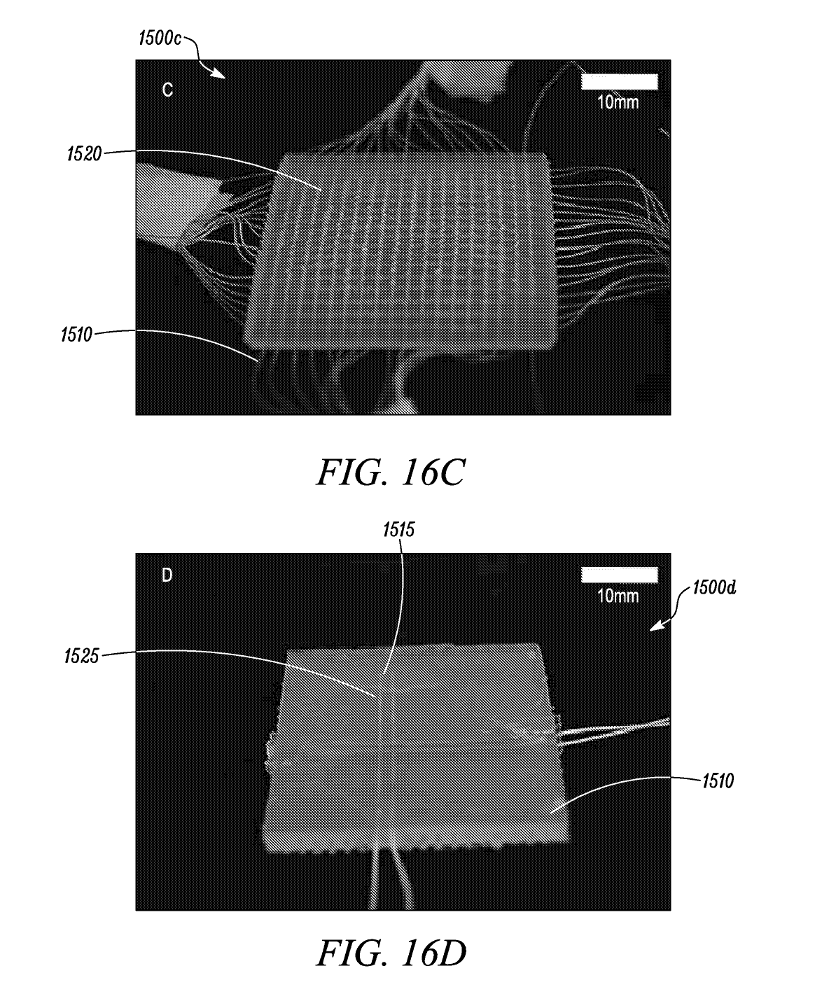

To characterize the response of stretchable electronic tactile sensors to an applied load, an experimental setup was built. FIG. 19A-19C shows a potential experimental setup for measuring sensor resistance or capacitance change under a given load. The setup consists of a high accuracy LCR meter, a mass loading frame for applying a point or surface load upon the sensor, and calibrated masses of various weights. The whole setup was put on an optical table to minimize environmental mechanical noise

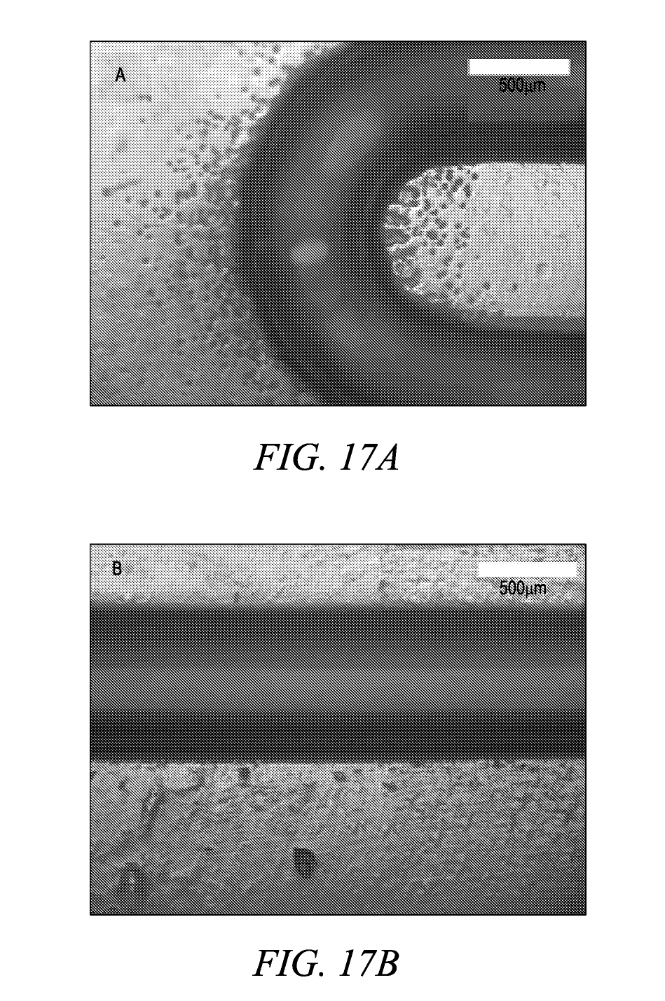

Measurements obtained using resistive stretchable electronic tactile sensors filled with EGaIn solution are shown in FIGS. 20A and 20B. To restrain the noise of low frequency and slow drifting of resistance readings at lower measurement frequencies, the LCR meter was set to 100 kHz during measurement. The EGaIn is highly conductive with only 1 ohm of resistance at zero load. The stretchable electronic tactile sensors experience an inertia zone and then a linear zone while adding mass. After the linear zone, the EGaIn moves into a nonlinear zone because further loading on the indentation stamp pinches off the channel since the stamp diameter is smaller than the size of sensor. The resistivity of 99 wt. % glycerine saline saturated solution is much higher than that of EGaIn. Starting from 70 Mohm in the relaxed state, the resistance rises up to 100 Mohm at a load of 300 g. Because the maximum range of the LCR meter is 100 Mohm, fewer measurement data points are plotted. However, from these limited data points, a clear linear relationship can be seen.

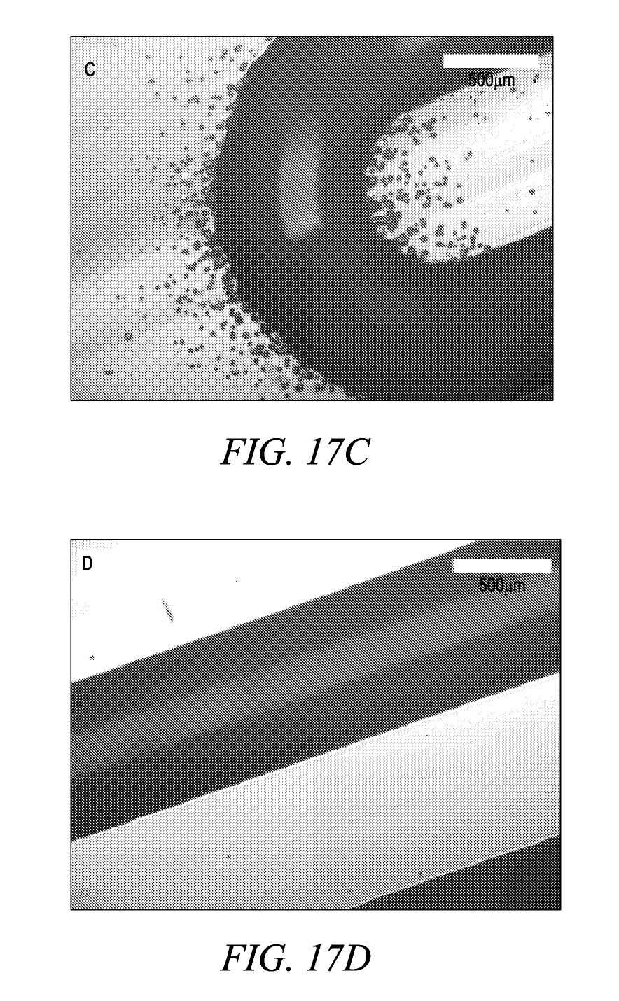

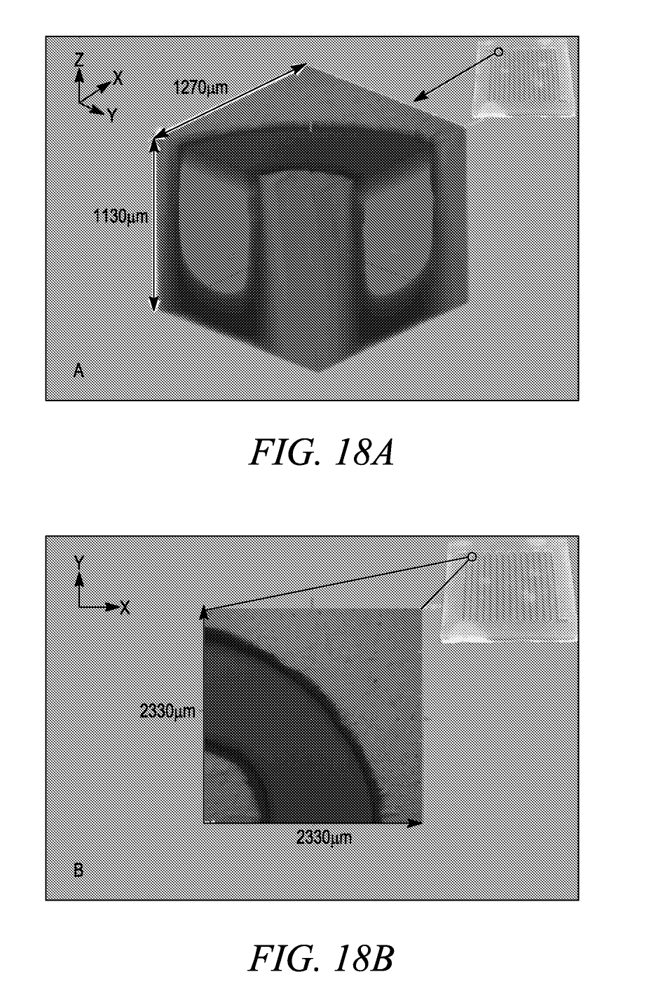

As shown in FIGS. 21A-21D, a capacitive sensor having a 4 pixel array was tested. An insulating indenting stick was used to apply the force on the upper-left corner of the 4 element sensing array as shown in FIG. 21B. The diameter of the tip of the stick was 6 mm. The space between the capacitor elements was 2 mm. Under a mass of 659 g on the stick, the static capacitances of the four elements were recorded by the LCR meter. The average capacitance of each element was plotted in FIG. 21D. The pixel closer to the indenting stick shows a larger capacitance than the other 3 pixels, due to the larger deformation induced by the indenting stamp which, in turn, reduces the distance between the two electrodes.

By increasing the number of pixels, higher resolution may be achieved. It is contemplated that arrays of stretchable electronic tactile sensors may be used to map information received from the stretchable electronic tactile sensors. The more pixels that are able to be used in an array of stretchable electronic tactile sensors per centimeter the higher the resolution. Using the stretchable electronic tactile sensors set forth above it is contemplated that at least 10 or more pixels per a square centimeter may be achieved, preferably at least 100 or more pixels per a square centimeter and most preferably 1000 or more pixels per square centimeter.

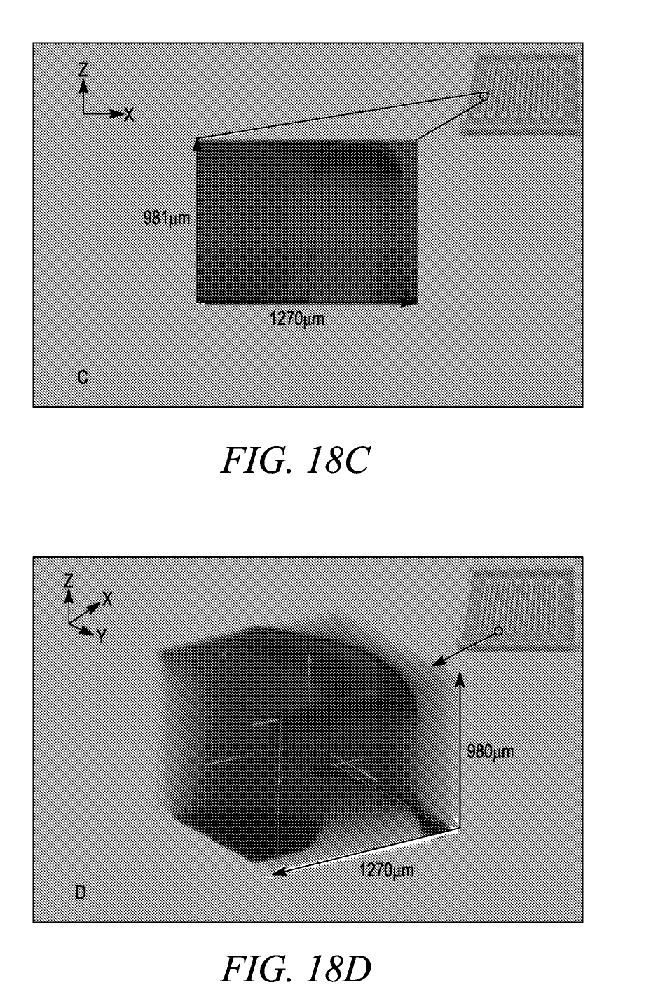

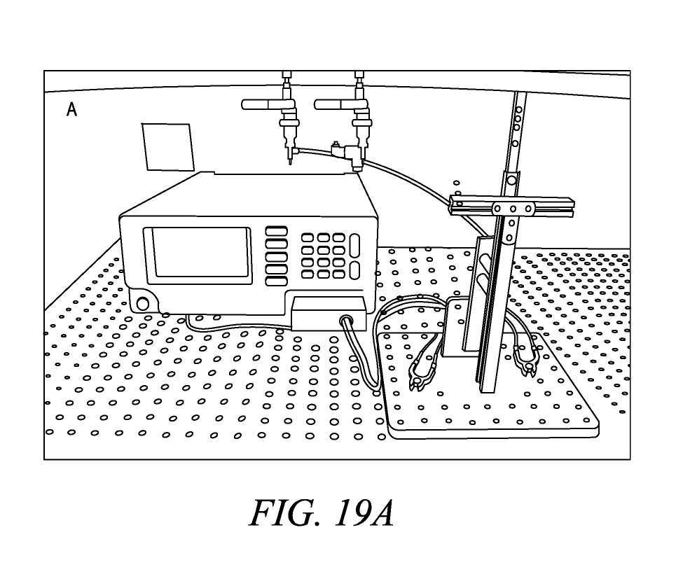

FIG. 22A illustrates a procedure for capacitive sensor array fabrication, based on direct filament casting and 3D photopolymer printing. The method includes steps of providing cast filaments (e.g., a diameter of 300 μm) and 1) coating them with release agent by spray coating (e.g. Ease Release 200™, Smooth-On, Inc.) and drying at room temperature. In step 2) the filament fixture mold is modeled in CAD and prepared using a photopolymer 3D printer (e.g. an Object30(a)™, Stratasys Ltd.), subsequently cleaned with isopropanol alcohol, then baked at 65° C. for 3 hours to eliminate any residual composites that would interfere with the silicone curing. Next, in step 3) the release agent coated filaments were fixed in parallel on two planes aligned perpendicular to one another. In step 4) uncured silicone rubber (e.g. Ecoflex 00-30™, Smooth-On, Inc.) was degassed under vacuum pressure (−29 inHg). In step 5) the degassed silicone rubber was cast into the mold and after a complete cure is achieved, the filaments are extracted under tension, leaving open channels in the silicone membrane. In step 6) the demolded membrane was transferred to a sealing mold, and in step 7) all open channels were sealed in an edge filling casting step. After the complete curing of the sealing material, eGaln or a eutectic material was injected into the channels via syringe, and i) fine electrodes were inserted, forming an electrical connection with the eGaln.

The stretchable electronic tactile sensors and the arrays formed therefrom may be able to be stretched more than 50% in at least one axial direction from the resting state of the stretchable electronic tactile sensor and the arrays formed therefrom. Preferably the stretchable electronic tactile sensors and the arrays formed therefrom may be able to be stretched more than 100% or more in at least one axial direction from the resting state of the stretchable electronic tactile sensor and the arrays formed therefrom. Most preferably the stretchable electronic tactile sensors and the arrays formed therefrom may be able to be stretched more than 200% in at least one axial direction from the resting state of the stretchable electronic tactile sensor and the arrays formed therefrom. Of course, a stretchability of less than 50% is also contemplated herein as discussed above.

Additionally, the stretchable electronic tactile sensors and the arrays formed therefrom may be able to be stretched more than 50% in at least two axial directions from the resting state of the stretchable electronic tactile sensor and the arrays formed therefrom. Preferably, the stretchable electronic tactile sensors and the arrays formed therefrom may be able to be stretched more than 100% or more in at least two axial directions from the resting state of the stretchable electronic tactile sensor and the arrays formed therefrom. Most preferably, the stretchable electronic tactile sensors and the arrays formed therefrom may be able to be stretched more than 200% in at least two axial directions from the resting state of the stretchable electronic tactile sensor and the arrays formed therefrom.

It is further contemplated that in addition to having stretchability in one or two axial directions, in preferred embodiments the stretchable electronic tactile sensors and the arrays formed therefrom may be able to achieve the same level of stretchability while retaining the capacity to provide high resolution sensing of greater than 10 pixels per centimeter, or greater than 50 pixels per centimeter or greater than 100 pixels per centimeter.

Capacitive and resistive sensors may be fabricated into arrays with higher spatial resolution, and good frequency response. However, capacitive sensing arrays are more susceptible to noise introduced by crosstalk, field interactions and fringing capacitance, requiring the integration of electrically grounded electrodes peripheral electronics to filter out the noise.

Also, modeling the capacitance as a function of geometry and influence from objects in proximity may be used. Based on current data, obtained for both resistive and capacitive tactile sensors, resistive sensors show a better anti-noise capability than capacitive sensors. The correct type of sensor for arrays will be chosen depending on the requirements of different practical applications.

Using the stretchable electronic tactile sensors and the fabrication methods described above, applications may be found in clinical palpation. The minimum requirements for sensors in terms of spatial resolution, frequency response, dynamic range and sensitivity to tissue softness differences may be obtained by using the spatial resolution and sensitivity of the devices in accordance with the present invention. Further numerical simulation work on complete sensor-tissue-finger models may be used to analyze required dynamic ranges and frequency responses.

In one aspect, the invention also relates to a method of palpating a patient using the stretchable electronic tactile sensor array described above. The method may comprise steps of: (1) palpating a patient using the stretchable electronic tactile sensor array, (2) acquiring data from the stretchable electronic tactile sensor array, and (3) mapping a property of tissue of the patient using said acquired data. The acquired data may comprise a resistivity of a conductive element or capacitance, as discussed in detail above. The property of the tissue may be selected from hardness and firmness and the method may be used to detect tissue inhomogeneities.

The stretchable electronic tactile sensors discussed above may be used with an elastic strain sensing array to image and detect subsurface abnormalities in simulated tissue. Palpation-independent invariant features may be constructed from the resulting measurements by examining the pressure-dependent growth of strain-energy density gradients captured by the sensor array. These invariants can be used to extract tissue mechanical properties such as firmness or hardness and/or to identify tissue inhomogeneities.

The stretchable electronic tactile sensors may be implemented as a glove-integrated wearable strain sensing array, and used to validate measurements captured during palpation using the simulated tissue set described above. Clinical examinations of subcutaneous abnormalities by palpation using simulated or real tissue may be further documented.

The stretchable electronic tactile sensors may also be used for prostate examinations. The requirements for skills assessment in prostrate examination can be analyzed, identified and translated into engineering requirements. Existing metrics for skills evaluation may be used to provide the comparison needed for the sensor output. The location, intensity, and temporal profile of touch applied during simulated prostrate examinations can be examined, compared to and implemented with stretchable electronic tactile sensors.

A wearable tactile sensing system using the stretchable electronic tactile sensors can be used to visualize on a computer the results of palpation. The use stretchable electronic tactile sensors to form arrays to in the form of a wearable device that may fit over irregular shaped objects can also provide an advantage over conventional stiff tactile sensing devices. Additional applications include minimally invasive surgery, medical diagnostics, robotics and prosthetics. With respect to robotics the stretchable electronic tactile sensors may be used to fit robotic devices of any shape or configuration and provide accurate tactile sensing.

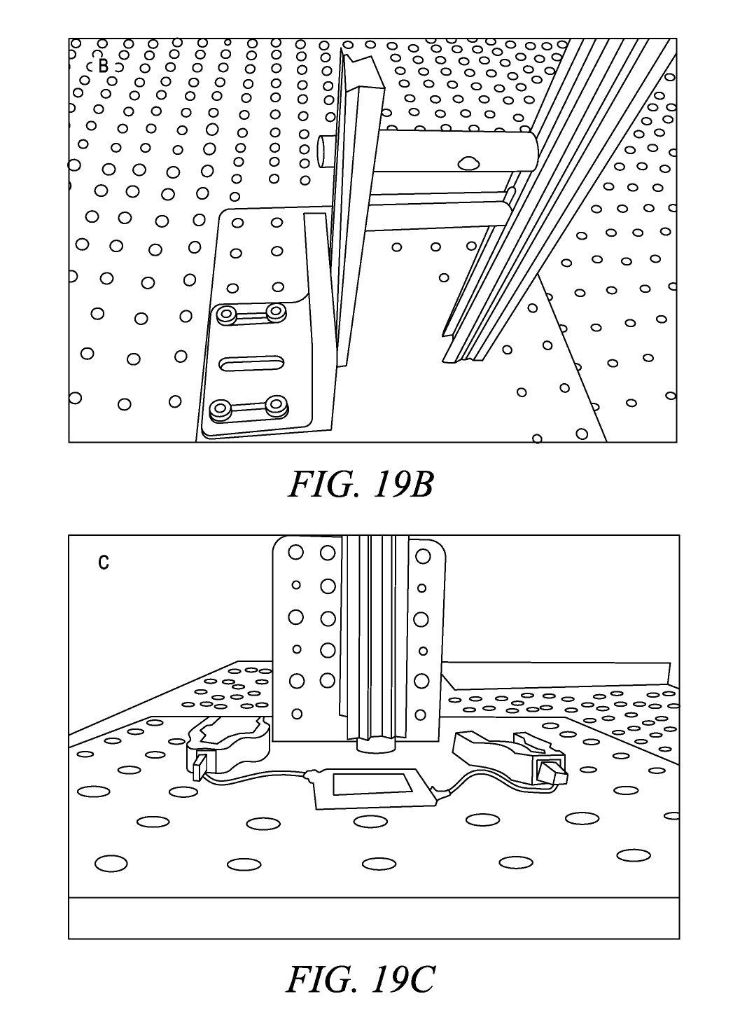

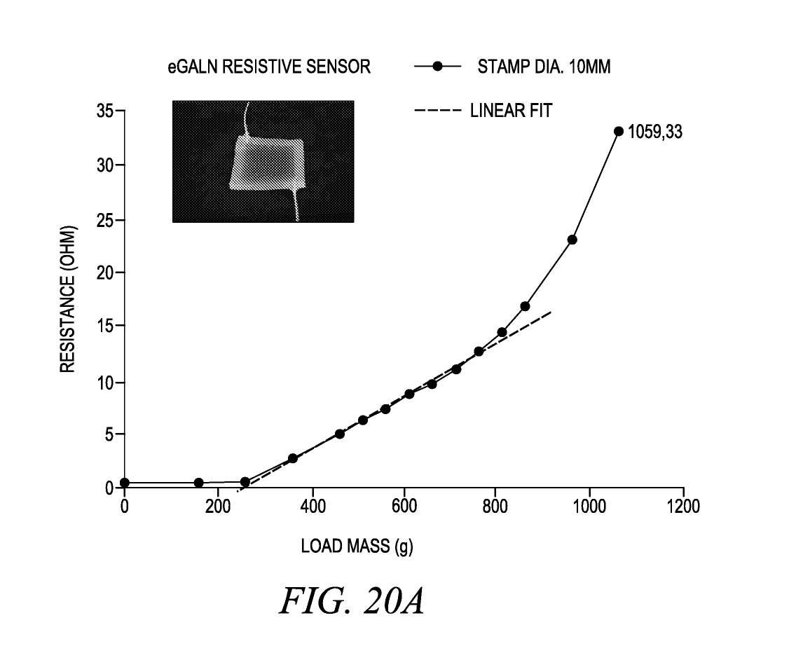

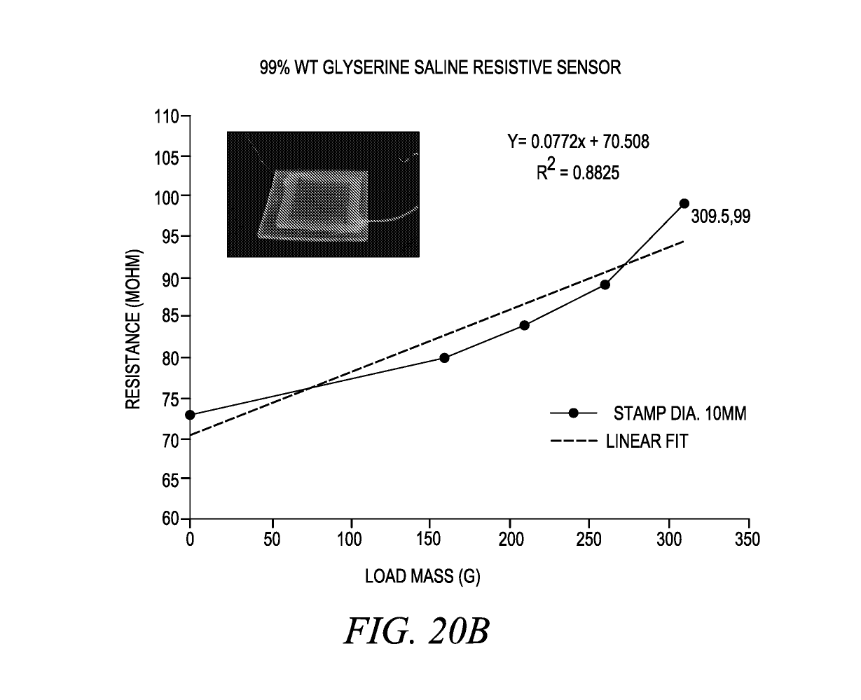

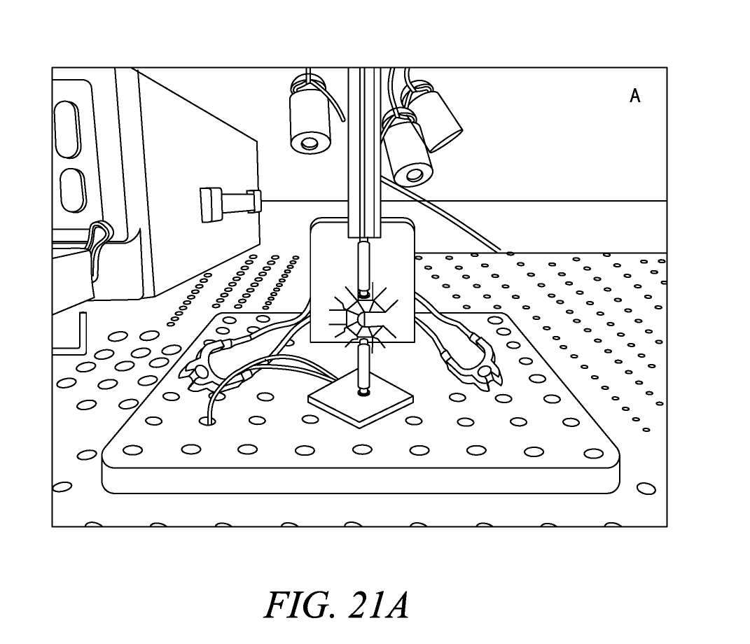

Highly stretchable capacitive tactile sensor arrays were fabricated by direct filament casting, using a mold constructed from arrays of fine nylon filaments guided by a 3D printed fixture frame. Two groups of microchannels were embedded in an orthogonal orientation on separate planes of a silicone polymer substrate as shown in FIG. 23A. Microchannels filled with eGaln served as electrodes for strain-sensitive capacitors. The change in electrical capacitance between every horizontal and vertical channel pair reflects the local strain in the region of intersection of the two channels. In this way, the capacitive sensing array is capable of detecting local strain through changes in capacitance resulting from deformation of the sensing array.

Since the mechanical properties of the material and geometry of the device are known, mechanical quantities, such as normal pressure or force, can be calculated.

A sample of the soft, stretchable tactile sensing array 2300, was fabricated via the direct filament casting. The fabricated sample capacitive sensing array fabricated using the direct filament casting method is shown in FIGS. 23A-23F. The basic configuration of the capacitive sensing array comprises an upper layer 2301 of microchannels and a lower layer 2302 of microchannels (FIG. 23A), which were filled with liquid alloy eGaln. In the device shown in FIG. 23D, the channel diameter was 300 μm, and the parallel channel spacing was 1700 μm, yielding a spatial resolution of 2 mm in an 8×8 channel array. The membrane thickness was 3 mm. The two microchannel planes divided the thickness evenly into 3 parts (FIG. 23B). After the microchannel array is filled with eGaln and sealed, it retains a high degree of stretchability, readily conforming to a human finger or a solid sphere with diameter of 1 cm (FIGS. 23E-23F).

TABLE 2
Geometric parameters used for capacitive sensing array fabrication

| | Configuration | Configuration | Configuration |
|---|---|---|---|
| Parameters | 1 | 2 | 3 |
| Spatial resolution | 2 mm | 1 mm | 1 mm |
| Capacitance upper | 1 mm | 100 μm | 200 μm |
| layer depth | | | |
| Capacitance lower | 2 mm | 500 μm | 600 μm |
| layer depth | | | |
| Device thickness | 3 mm | 1 mm | 1 mm |
| Mold size | 4 cm × 4 cm | 3 cm × 3 cm | 3 cm × 3 cm |
| Microchannel diameter | 300 μm | 300 μm | 200 μm |

Each eGaln-filled microchannel functions as an electrode, forming a capacitor with every orthogonal microchannel in the opposing layer. Using electromagnetic transmission line coupling theory and solid mechanics, an analytical model for the strain-induced change in mutual capacitance between orthogonal channel pairs was developed. The model was experimentally validated through indentation testing yielding good agreement with measurements. The dominant effect was found to be due to bulk compression of the sample, which yielded an increase in capacitance due to a reduction in inter-channel distance. The effective mutual capacitance between an electrode pair can be expressed as

$${C}_{eff} = \frac{2 πɛ}{log [ {h}_{2} / r + \sqrt{{( {h}_{2} / r )}^{2} - 1} ]} {\int }_{0}^{L / 2} \frac{log [ \frac{{x}^{2} + {( {h}_{2} + {h}_{1} )}^{2}}{{x}^{2} + {( {h}_{2} - {h}_{1} )}^{2}} ]}{log [ \frac{4 {h}_{1}^{2}}{{r}^{2}} ] - log [ \frac{{x}^{2} + {( {h}_{2} + {h}_{1} )}^{2}}{{x}^{2} + {( {h}_{2} - {h}_{1} )}^{2}} ]} dx \qquad ( 1 )$$

where L is the length of the conductive channel, h₁ and h₂ are the respective distances between the channels and the ground surface, r is the channel radius, and ε is the material permittivity. A ground surface at the base of the sensor mimics the measurement configuration. This model of the mutual capacitance between the two orthogonal conductive channels is depicted in FIGS. 3A-3B.

Compressing the sample yields an engineering strain c that decreases the vertical displacement between electrodes, so that h′ᵢ=hᵢ (1−ε), for i=1, 2. By substituting this relationship in equation (1), the extent of change in C_{eff} with strain ε can be predicted. Continuum mechanics dictates that the electrode shape also deforms when subjected to an applied stress; this would also affect capacitance, but the correction can be shown to be suppressed by a factor (r/h₂)², and thus this parameter can be neglected in the model. In the large strain limit (ε→1), Equation (1) predicts a quadratic change in capacitance with strain, C_{eff}=C₀+αε², where α is a geometry-dependent constant. The resulting predictions were assessed using measurements taken using indentation testing.

An overview of the direct filament casting method is shown in FIG. 22. The fabrication consisted of three main stages, starting with casting mold preparation at steps (1) to (3), followed by the casting of silicone polymer and channel terminal sealing at steps (4) to (7). Lastly, at steps (8) and (9), all the channels were injected with eGaln and the electrodes were inserted into the channel ends for electrical interfacing.

A filament fixture frame was designed in CAD software and printed using a photopolymer 3D printer (Object30™, Stratasys Ltd.). As shown in FIG. 22, after the printing and cleaning of the frame, at steps (1)-(3), nylon filaments (South Bend Monofilament™, 200 or 300 μm diameter) were spray coated with silicone polymer casting release agent (Ease Release 200, Smooth-On, Inc.) and arranged in tension on two planes, guided by the frame. At step (4), liquid silicone polymer components were mixed and poured into the mold for curing. After curing, at step (5), filaments were extracted under tension, forming a membrane with open microchannels embedded in two layers. After sealing at step (7), all microchannels were filled with eGaln via syringe injection at step (8). At step (9), electrodes were then inserted to functionalize the stretchable capacitive sensing array.

The diameter of the microchannel is determined by the diameter of the casting filament. A larger channel diameter yields a higher nominal capacitance value. In this example, the relation between spatial resolution and capacitance magnitude was explored and it was determined that a diameter of 200 μm to 300 μm yielded the best results.

To further examine the possibility of fabricating smaller features, on the order of a few μm, with this method, the spacing was varied, Δs, of adjacent parallel channels and the separation, Δd, of upper and lower channel layers. Filament positioning was constrained by the resolution of the fixture frame, which was limited by the 3D printer resolution (600 dpi, or 42 μm). Using filaments of diameter 300 μm, devices were fabricated with spacings of 100, 200, 700, and 1700 μm. Channel layer separations of 8 to 30 μm were achieved.

Thinner sensing arrays were fabricated using the same method to achieve higher resolution, including 23×23 microchannel sensing arrays with thicknesses 1 mm and spatial resolution of 1 mm×1 mm. The two microchannel planes were positioned at depths of 400 μm and 800 μm from the top surface. Stretchability of over 400% was achieved without damage.

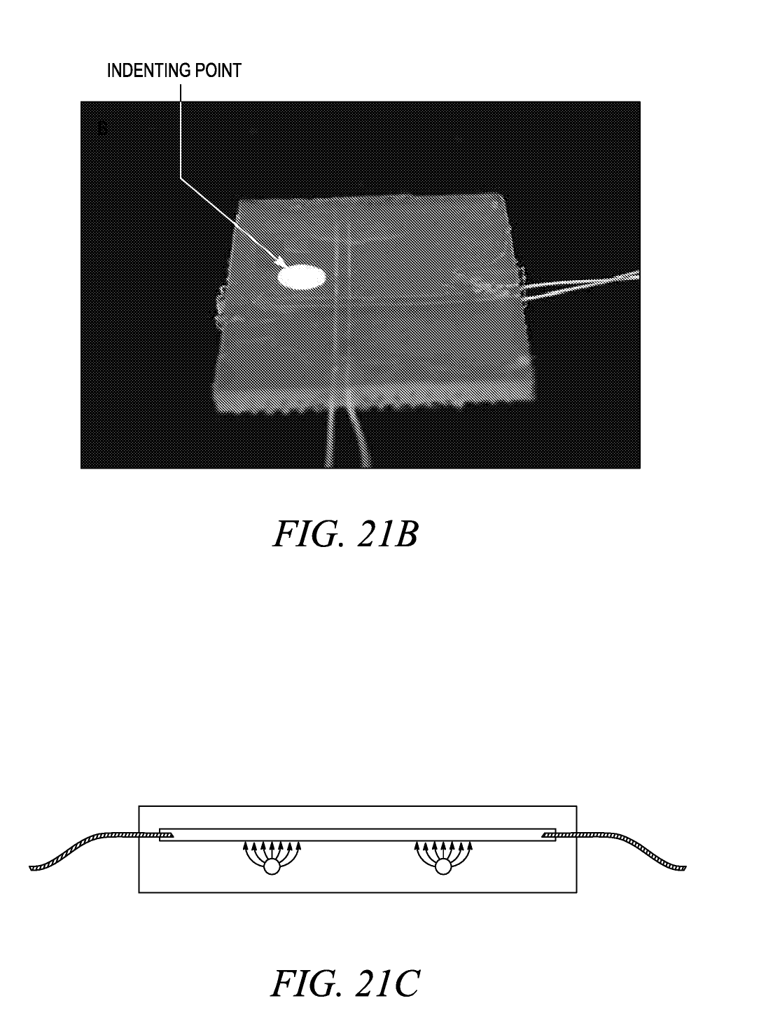

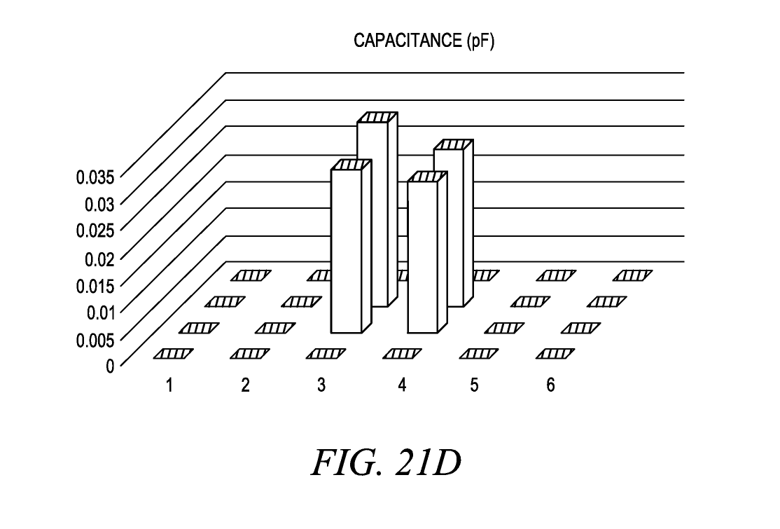

FIGS. 24 and 25 illustrate a top view of a 9×9 stretchable tactile sensor and a sectional view of the stretchable tactile sensor shown in FIG. 24, respectively, according to an embodiment of the present invention. As shown in FIGS. 24 and 25, the stretchable tactile sensor includes an elastomeric membrane 2501 including a first parallel array of microfluidic channels 2502 and a second parallel array of microfluidic channels 2503. The stretchable tactile sensor shown in FIGS. 24 and 25 is based on mutual capacitance sensing. The first parallel array of microfluidic channels is orthogonal to the second parallel array of microfluidic channels. A pressure applied to the surface of the sensor reduces the inter-electrode distance between the first and second parallel arrays of microchannels and increases mutual capacitance between the electrodes. The stretchable tactile sensor of FIGS. 24 and 25 also includes an array of micropillar structures 2504 with air cavities 2505. As described above, by varying the pillar width, the stretchable tactile sensor can be tuned according to a particular application's requirements.

In one embodiment, an elastomeric membrane includes a first parallel array of microfluidic channels aligned orthogonally to a second parallel array of microfluidic channels. A conductive liquid is also introduced into the first and second parallel arrays of microfluidic channels to functionalize the elastomeric membrane as a stretchable tactile sensor. In this way, the first and second parallel arrays of microfluidic channels filled with the conductive liquid function as embedded electrodes in a highly elastic substrate. When a surface pressure is applied, the inter-electrode distance (e.g., the distance between the microfluidic channels of the first parallel array and the second parallel array) is reduced, increasing mutual capacitance between the electrodes. The sensor measures this change in mutual capacitance and combines it with electronic and mechanical measurements obtained during calibration to map the sensed capacitance values to a local strain or pressure.

For instance, during touching and manipulation of objects, such as during palpation, the stretchable electronic tactile sensors are exposed to pressure substantially normal to the substrate and lateral stresses, causing normal and tangential strains on the substrate and the microchannels. These strains induce electrical changes in the conductive microchannels. The induced deformations occurring at an array of different points is read by measuring changes in electrical resistance on capacitance within the matrix of microchannels. These stretchable electronic tactile sensors are able to measure the sensed touching and manipulation of objects.

Another embodiment further includes an array of geometric structures (e.g., micropillar structures) positioned between the first parallel array of microfluidic channels and the second parallel array of microfluidic channels. The array of micropillar structures may be used to control and/or tune the mechanical properties (e.g., stiffness and/or softness) of the stretchable tactile sensor. For instance, as the pillar width of the micropillars is reduced, the effective stiffness of the sensor is reduced and the pressure-induced strain is increased, yielding a more rapid increase in capacitance with pressure. In this way, the tactile sensors of the present invention can be tuned to an operating range of pressures according to a particular application's requirements.

The elastomeric membrane includes a curable low-modulus synthetic polymer. In one embodiment, the elastomeric membrane is based on polydimethylsiloxane (PDMS). PDMS is viscoelastic and generally optically clear, inert, and non-toxic. While PDMS is provided as a preferred embodiment, the elastomeric membrane can be based on any soft synthetic polymer.

Each of the first array of microfluidic channels and the second array of microfluidic channels includes a parallel arrangement of microfluidic channels. The spacing between the parallel microchannels on each of the first array and the second array is constant, with the first parallel array of microfluidic channels aligned perpendicular (e.g., orthogonal) to the second parallel array of microfluidic channels. Generally, spacing between each microfluidic channel of the first and second arrays of microfluidic channels is constant within each layer, but in some embodiments the spacing can vary. In embodiments where the spacing is constant, the center-to-center spacing can determine the spatial sensing resolution. In some embodiments, the spatial resolution can be 0.5 mm or less, with noupper limit. The orthogonal orientation of the microchannels of the first array relative to the second array forms a stretchable tactile sensor based on mutual capacitance sensing. Other embodiments can include non-parallel arrangements of microchannels and spacing between microchannels that varies (e.g., not constant).

As discussed in more detail elsewhere, during fabrication, a plurality of filaments are wound around a mold. After curing the polymer to form the membrane, the filaments are extracted from the mold to form the microchannels. The geometric configuration of a cross-section of the microfluidic channels resembles the cross-sectional shape of the filament and/or monofilament wound around the mold. The geometric configuration and size of the cross-section of the microfluidic channels can be tuned according to the filament used for fabrication.

The elastomeric membrane is embedded with liquid metal electrodes and/or soft electrodes in microfluidic channels. The first array of microfluidic channels and/or the second array of microfluidic channels can initially contain no conductive liquid, during, for example, fabrication. The first array of microfluidic channels and/or the second array of microfluidic channels can be functionalized by introducing a conductive liquid into the microfluidic channels of the first array and of the second array. The conductive liquid can include a liquid metal alloy. In some embodiments, the conductive liquid includes one or more of a eutectic alloy, a conductive polymer, a conductive gel, a conductive paste, an ionic solution, and a conductive thread. In some embodiments, the conductive liquid includes eutectic gallium indium.

The elastomeric membrane includes an array of geometric structures (e.g., micropillars). Micropillars are designed and/or selected based on the application. By varying the micropillar width, the stretchable tactile sensor can be tuned to an operating range of pressures according to a particular application's requirements. For instance, by reducing the pillar width, the effective stiffness of the layer is reduced and the pressure-induced strain is increased, yielding a more rapid increase in capacitance with pressure. In a preferred embodiment, the array of micropillar structures form a layer positioned between a layer including the first parallel array of microfluidic channels and another layer including the second parallel array of microfluidic channels. The micropillars are centered between the microfluidic channels of the other two layers such that, when viewed from above, the micropillars are separated by a contiguous free space. The layer with the array of micropillar structures includes air cavities separated by the micropillar supports. The layer with the array of micropillar structures supports the layer with the first parallel array of microfluidic channels and the other layer with the second parallel array of microfluidic channels. In this way, the effective stiffness of the tactile sensor can be tuned by varying the micropillar width.

The following model and/or mathematical relationship can be used for design purposes, for example. In some embodiments, with respect to small strains, the layer containing the micropillar structures can be modeled as a linear elastic solid, with an elastic modulus E. The effective stiffness K of the micropillar layer can be approximated by the following formula:

K=EA/tₚ=ENₚwₚ²/tₚ

where tₚ is the thickness of the layer including the micropillar array of geometric supports and A=Nₚwₚ² is the cross-sectional area of the micropillar layer, with Nₚ representing the number of micropillars and wₚ representing the width of the micropillars. In this embodiment, this relationship illustrates a quadratic dependence of stiffness on pillar width, indicating that wₚ can be a useful design parameter. In some embodiments, with respect to larger strains, the above relationship no longer holds, but the qualitative conclusion remains the same.

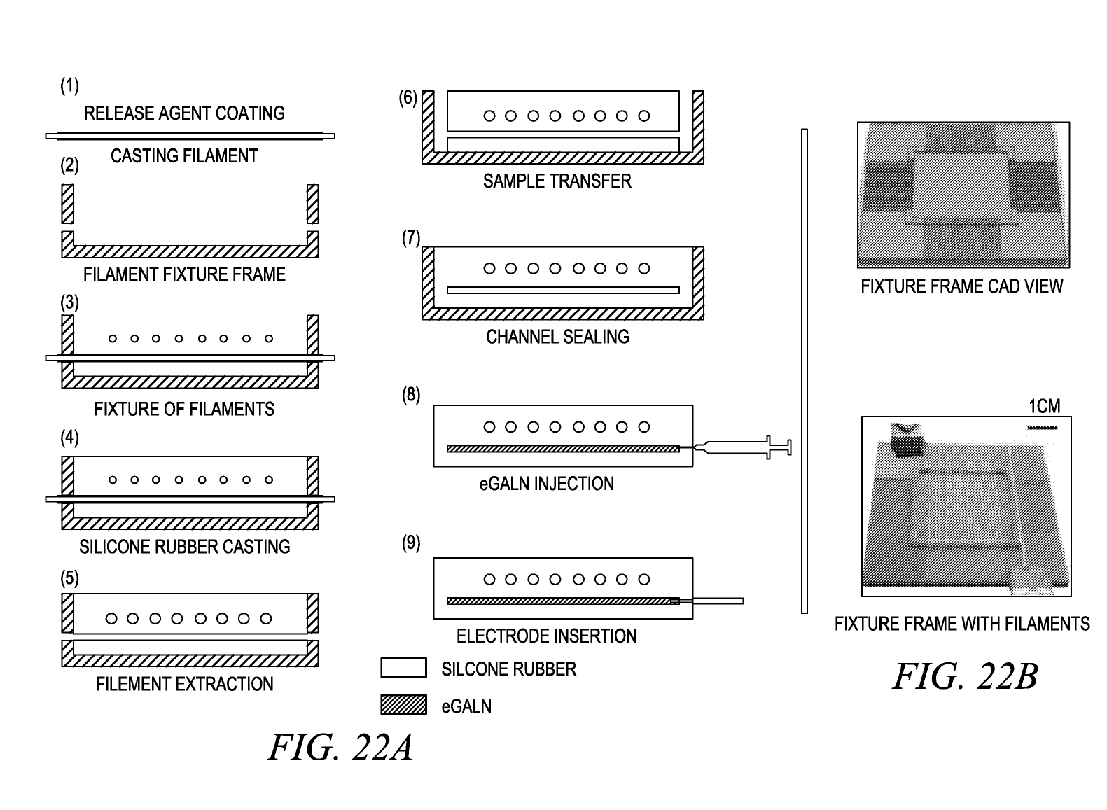

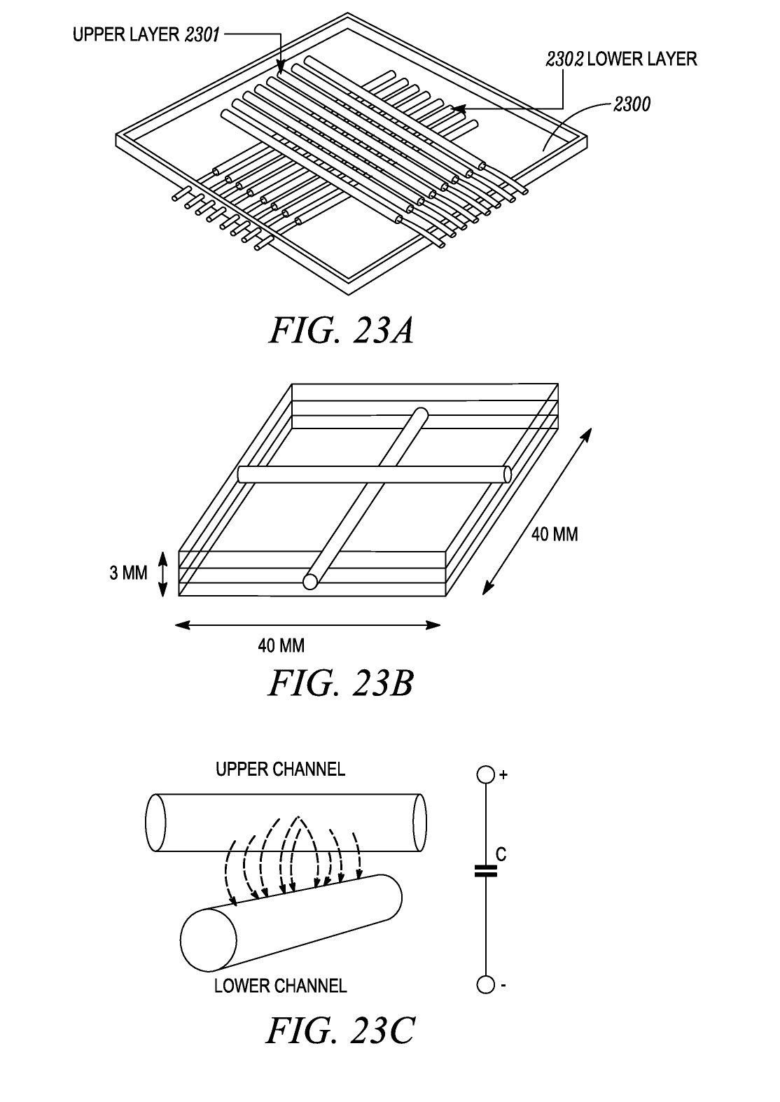

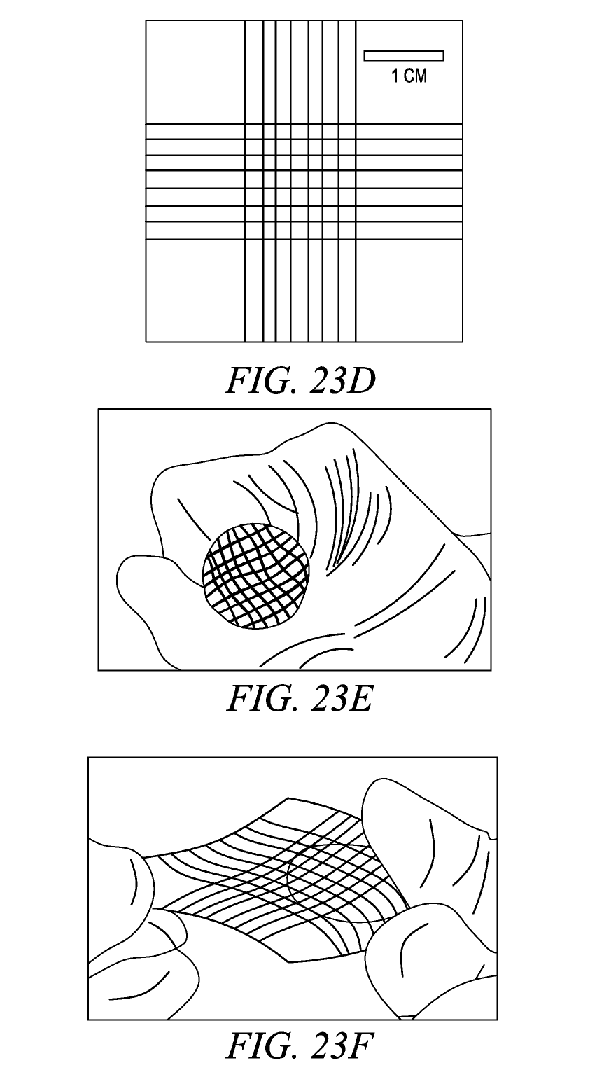

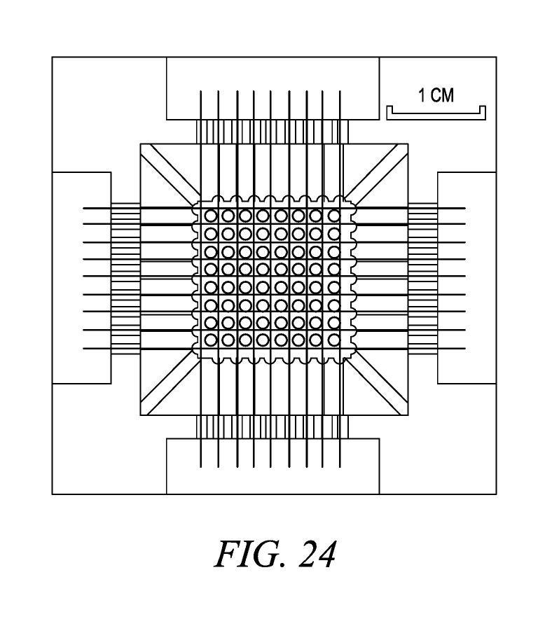

The mechanical and electronic performance of the stretchable tactile sensor improves with the addition of the layer including the array of geometric structures. In some embodiments, including a layer with the array of geometric structures and air cavities between the layer with the first parallel array of microfluidic channels and the layer with the second parallel array of microfluidic channels (e.g., to form a three-layer thin membrane) improves one or more of sensitivity, monotonic output, linear response, cross-talk, rate dependence, and hysteresis. In some embodiments, the three-layer thin membrane produces a stretchable tactile sensor exhibiting one or more of high sensitivity, monotonic output, linear response, low cross-talk, low rate dependence, and low hysteresis. FIGS. 26(a)-(d) illustrate additional views of the stretchable tactile sensor of FIG. 24, according to one or more embodiments of the present disclosure. FIG. 26(a) illustrates a top view of a 9×9 sensing array, according to one or more embodiments of the present disclosure. FIG. 26(a) also shows interface elements P1, P2, P3, and P4 located adjacent to the main membrane to insulate the microchannels from mechanical stresses induced during testing. FIG. 26(b) illustrates a magnified top view of a stretchable tactile sensor showing the configuration of microchannels and micropillars, according to one or more embodiments of the present disclosure. As shown in FIG. 26(b), the position of each micropillar relative to proximate microfluidic channels of the lower and upper layers is characterized by a distance, d. In addition, the space between each microchannel of the upper layer and the space between each microchannel of the lower layer is characterized by a distance, S. FIG. 26(c) illustrates a sectional view of a stretchable tactile sensor showing the stretchable tactile sensor's multilayer structure, according to one or more embodiments of the present disclosure. FIG. 26(d) illustrates a sectional view of a stretchable tactile sensor showing the stretchable tactile sensor's multilayer structure, according to one or more embodiments of the present disclosure.

As described above, the stretchable tactile sensors of the present invention are highly stretchable. The stretchable tactile sensors of the present invention can be embodied in a stretchable material, structure, device, or component of a device. In some embodiments, a stretchable material, structure, device, or component of a device can be stretched in at least one dimension without introducing permanent deformation larger than or equal to about 5%. In some embodiments, a stretchable material, structure, device, or component of a device can be stretched in at least one dimension without introducing permanent deformation larger than or equal to about 1%. In some embodiments, a stretchable material, structure, device, or component of a device can be stretched in at least one dimension without introducing permanent deformation larger than or equal to about 0.5%. In some embodiments, a stretchable material, structure, device, or component of a device can be stretched in at least one dimension by about 1% or more, 10% or more, 50% or more, 100% or more, or 200% or more.

The tactile sensors of the present invention provide new opportunities in, for example, biomedical imaging of soft tissues during clinical palpation, robotics, prosthetics, electronic skin, wearable sensing electronics, and virtual reality, among other things. The tactile sensors of the present invention include thin membranes integrating arrays of tactile sensors. The tactile sensors of the present invention are highly stretchable, highly conformable and/or deformable, and highly compliant and can be adapted to curved and dynamic surfaces. The tactile sensors of the present invention perform sensing while preserving high stretchability, resiliency, spatial resolution, sensitivity, and dynamic response. The tactile sensors of the present invention exhibit high sensitivity, monotonic output, linear response, low cross-talk, low rate dependence, and low hysteresis. The tactile sensors of the present invention are mechanically tunable and electronically responsive.

The tactile sensors of the present disclosure can be stretchable soft electronic tactile sensors to meet requirements with respect to wearability and conformability. The tactile sensors of the present invention employ microfluidic sensing. The stretchable electronic tactile sensors can include elastic membranes with embedded microchannels carrying water-based ionic fluid solutions such as glycerol saline, among others. The elastic membranes can be microfabricated by casting low-modulus elastomers using accurate photopolymer-based 3D printing and soft lithography methods that are used in soft robotics and other areas.

The tactile sensors of the present invention can further include multilayer sensing arrays in the form of a composite membrane constructed from three or more layers. In particular, the tactile sensors of the present invention can be based on multilayer heterogeneous 3D structures that combine two or more active layers containing embedded liquid metal electrodes and/or soft electrodes in microfluidic channels with one or more passive and mechanically tunable layers containing air cavities and micropillar array geometric supports. For instance, some embodiments of the present invention include a composite membrane constructed from three layers. This embodiment can contain two layers with arrays of soft electrodes and a third layer can contain the air cavities and micropillar structures. To achieve high levels of compliance, the layers can be cast from low modulus synthetic polymer and combined to yield a thin multi-layer membrane.

The tactile sensors of the present invention can maintain electrical and mechanical integrity, while conforming to a wide range of objects and surfaces, without impairing its tactile sensing capabilities. The tactile sensors of the present invention can conform to non-planar, compliant, irregularly-shaped, and curved objects, as well as objects that change dynamically, without undergoing permanent deformation that would impair its tactile sensing capabilities. The tactile sensors of the present invention can capture shear strains, in addition to normal strains.

The present invention also relates to methods of fabricating tactile sensors. In one embodiment, direct filament casting implements a soft lithography method that integrates a 3D printing-based casting technique to facilitate the fabrication of networks of liquid metal electrodes in very low modulus polymer membranes. The methods of the present invention can be based on the casting, alignment, and fusion of multiple functional layers in a soft, addition-cured polymer substrate. It can also include functionalizing through the introduction of liquid metal into conductive microchannels. The methods of the present invention can be used to create intrinsically deformable, heterogeneous membranes and to provide control over mechanical and electronic performance, among other characteristics readily apparent to a person of skill in the art.

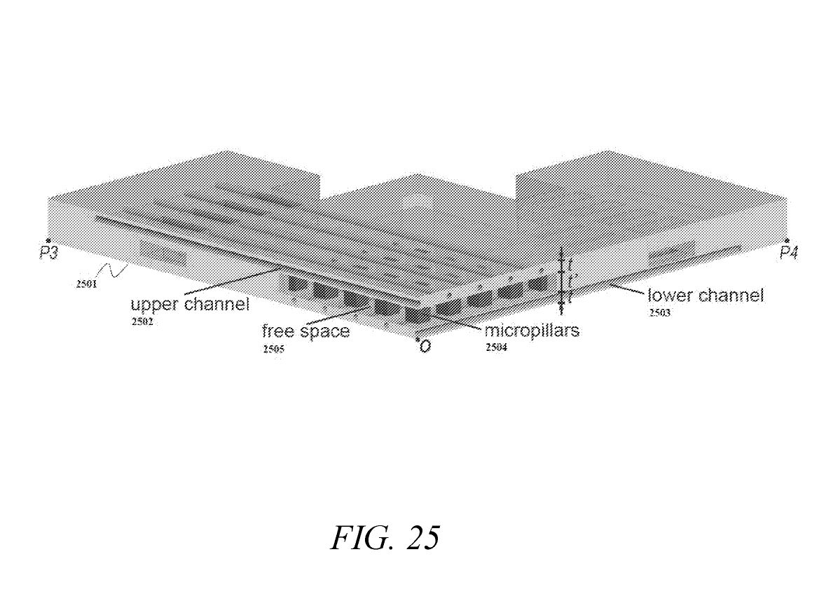

FIG. 27 illustrates a block flow diagram of a method of fabricating a stretchable tactile sensor, according to an embodiment of the present disclosure. As shown in FIG. 27, the method of fabricating a tactile sensor 700 includes, at step 701, providing a mold for filxing a plurality of filaments in parallel on a first plane and a second plane. In some embodiments, the filaments of the first plane are aligned orthogonally to the filaments of the second plane. At step 702, curable material is cast into the mold. At step 703, the curable material cast into the mold is cured to form a membrane. At step 704, the plurality of filaments are extracted from the membrane to form microfluidic channels in the membrane. At step 705, the membrane is functionalized by introducing a conductive liquid into the microfluidic channels of the membrane. The methods of fabricating a tactile sensor 700 have proven to be robust, repeatable, and amenable to fabricating more complex geometries that can easily be realized with photolithography methods.

In another embodiment, the method of fabricating a tactile sensor comprises providing a mold for fixing a plurality of filaments in parallel on a first plane and on a second plane, the filaments of the first plane aligned orthogonally to the filaments of the second plane, and also providing the mold for constructing an array of geometric structures (e.g., micropillars) on a third plane positioned between the first plane and the second plane.

The mold is constructed from a 3D printer, such as a photopolymer 3D printer. In one embodiment, two negative molds are provided, including a first negative mold and a second negative mold. The first negative mold includes fixture teeth for fixing filaments around the mold to form the first plane of microfluidic channels and the array of micropillar structures. The second negative mold includes fixture teeth for fixing filaments around the mold to form the second plane of microfluidic channels. In some embodiments, a surface release agent is spray-coated on the first negative mold and the second negative mold to aid in extracting the filaments from the membrane.

The curable material is a low-modulus synthetic polymer, such as PDMS. The curable material is mixed and degassed before being cast and/or poured into the first negative mold and the second negative mold. A cover, such as an acrylic cover, can be used to close the mold and/or squeeze out extraneous polymer material.

The curable material is cured for about 6 hours at about 60° C. The temperature and duration required for curing the curable material depends on the curable material used. Curing can also occur for about 15 minutes at about 60° C., about 6 hours at about 60° C., and/or about 30 minutes at about 60° C.

In some embodiments, the methods of fabricating a stretchable tactile sensor can include additional steps. In some embodiments, the methods of fabricating a stretchable tactile sensor further comprise demolding by heating for a period of time. In one embodiment, having removed the filaments from the mold to create the microfluidic channels, the ends of those channels currently open to the outside are sealed prior to filling the channels with the liquid conductive material. For instance, syringe injection of a liquid polymer can be used to seal the ends of the open channels. In some embodiments, the methods of fabricating a stretchable tactile sensor further comprise applying a bonding film to one or more of the first membrane and the second membrane prior to aligning. In some embodiments, the methods of fabricating a stretchable tactile sensor further comprise partially curing the bonding film. In some embodiments, the methods of fabricating a stretchable tactile sensor further comprise aligning the first plane with the second plane sufficient to position a parallel array of microfluidic channels in the first plane orthogonally to the parallel array of microfluidic channels in the second plane. In some embodiments, the methods of fabricating a stretchable tactile sensor further comprise aligning the array of geometric structures between microfluidic channels of the first plane and the second plane. In some embodiments, the methods of fabricating a stretchable tactile sensor further comprise functionalizing the membrane by introducing a conductive liquid into the microfluidic channels of the first plane and the second plane. In some embodiments, the methods of fabricating a stretchable tactile sensor further comprise comprising terminating via insertion of wires and sealing.

The following Examples are intended to illustrate the above invention and should not be construed as to narrow its scope. One skilled in the art will readily recognize that the Examiners suggest many other ways in which the invention could be practiced. It should be understand that numerous variations and modifications may be made while remaining within the scope of the invention.

### EXAMPLES

### Example 1—Functional Testing

Two sets of experiments were employed to characterize the sensor response to displacement-controlled indentation, based on quasi-static characterizations of individual sensing elements in the array, and on tactile imaging with a spatially distributed sensor array.

The first experiment characterized the stress and strain response of an individual capacitive sensing element by indentation testing, using a circular metal plate with a diameter of 4 mm centered at the intersection of two channels. Contact surface pressure and capacitance change were measured simultaneously as functions the imposed vertical indentation depth.

Capacitance was measured using an LCR meter (LCR-819™, GW Instek) in parallel circuit mode, with a probe frequency of 100 kHz.

A high resolution force test stand (ES-20 and M5-20, Mark-10, Inc.) was used to apply vertical indentation and to measure displacement and force. Testing was performed with a single sensing element comprised of two orthogonal microchannels, as shown in FIG. 22B, with a channel diameter of 300 μm, a channel layer separation of 700 μm and a thickness of 3 mm.

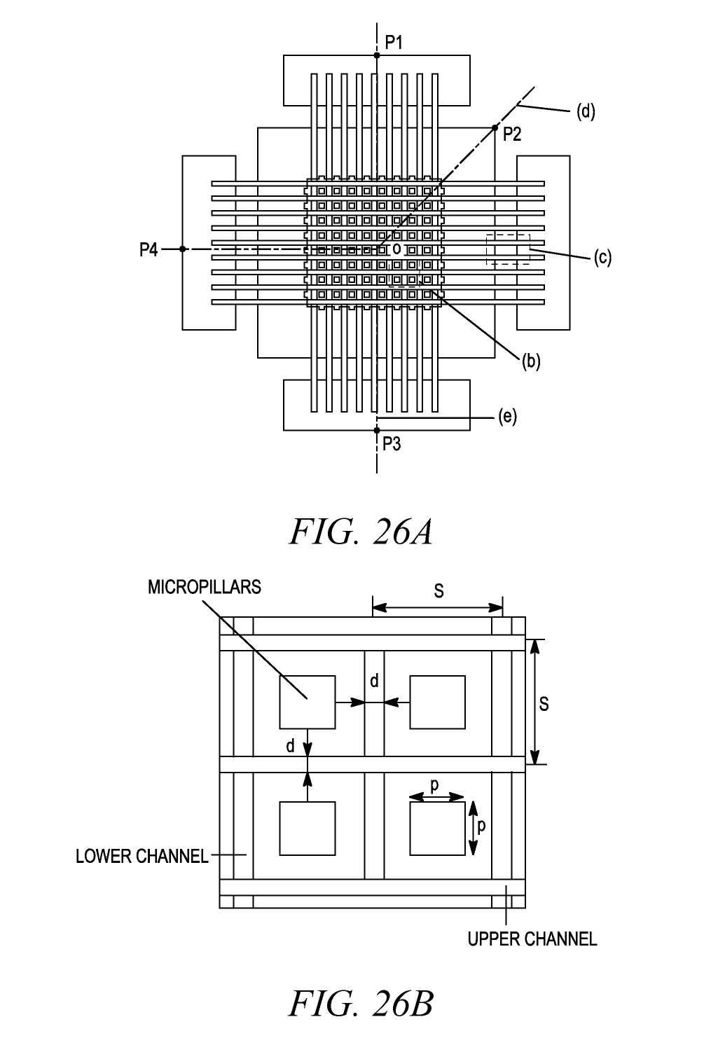

Capacitance values were measured via LCR meter (LCR-819, GW Instek), and averaged over 5 readings. FIG. 28 shows the change in capacitance with increasing load, compared with predictions of the model of Eq. 1, demonstrating excellent qualitative and quantitative agreement over the displayed range.

Without load, the capacitance C₀ was 0.32 pF (LCR meter, LCR-819, GW Instek; FIG. 7a). Percent capacitance change increased monotonically to a maximum of 240% under a pressure of 630 kPa (FIG. 28). Capacitance increased monotonically over a range from 50 kPa to 450 kPa, as shown, and extended to 600 kPa (off scale). At very high pressure and strain (p>630 kPa, ε>0.95, not shown) capacitance decreased abruptly, due to the collapse of one or both microchannels and concomitant loss in electrical connectivity.

These measurements were compared to the model predictions by evaluating the integral expression (Eq. 1) numerically for values of strain up to ε=0.75 (equivalent to a pressure of 180 kPa), and utilizing a quadratic approximation for large strain values. As illustrated in FIG. 28, the model exhibits excellent qualitative and quantitative agreement with measurements at both low values of strain, where it correctly predicts a non-monotonic nonlinear change in capacitance, and high values (ε>0.75), where a quadratic regime was observed.

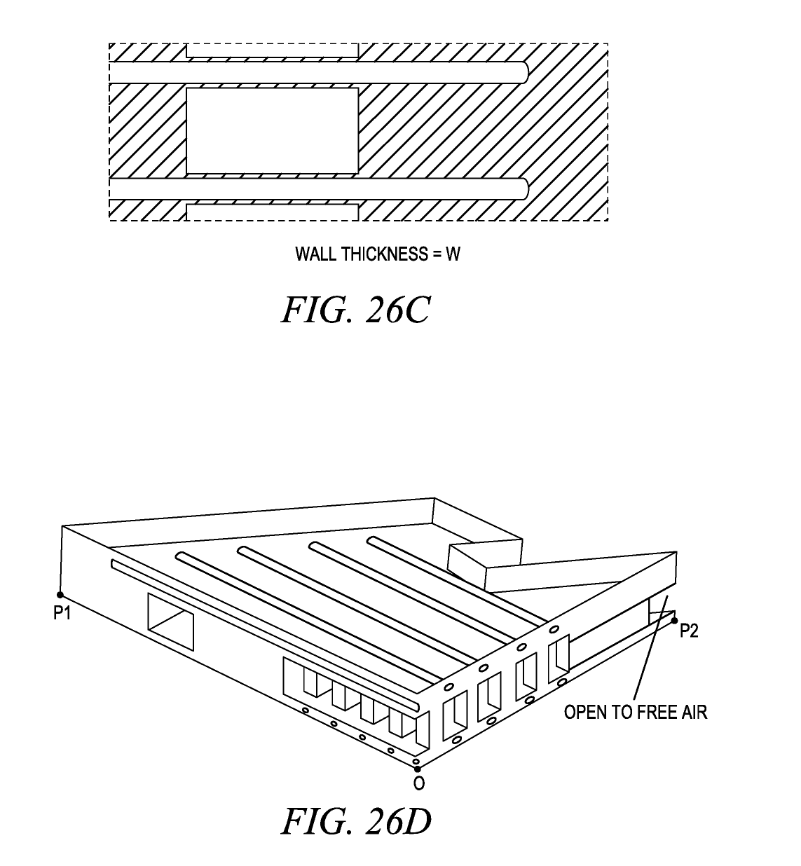

In a second set of experiments, we evaluated the spatial imaging capabilities of the array using indentation stamps of varying geometry. Measurements were recorded with the test setup described above. Percent capacitance change was recorded under strain-controlled loading and the results are shown in FIGS. 29A-29F. A circular indentation plate with diameter of 4 mm (enclosed by dash line) was used to indent the 8×8 capacitive array. Two indentation depths were used: 1.88 mm and 2.41 mm.

A plastic four-point stamp was used to indent the sensing array, each point contacting the device at a circular area with a diameter of 2 mm. Sensing elements within the indented area (denoted by dashed circles) demonstrated increased capacitance, while the adjacent elements outside this area did not. The use of a plastic tip also led to reduced fringing electromagnetic field effects in nearby sensing elements (FIG. 29D). Since the contacting material cannot generally be specified, further measures for electromagnetic disturbance rejection are adopted below. A cross-shaped indentation stamp yielded increased capacitance over a similarly shaped area (FIG. 29F).

Compared to existing fabrication techniques, the direct filament casting method is low in cost and complexity, yields high resolution and sensitivity, and does not require specialized facilities. With this method, fabrication can be accomplished via a single-step casting procedure without requiring the alignment and binding of multiple polymer sheets, as are required by conventional soft lithography methods. The channel diameter, channel spacing and channel layer separation can be directly controlled by selecting geometric parameters of the casting filament and 3D printed fixture frame. The fabricated sensing array can readily be stretched over 400% deformation without damage. A monotonic increase of capacitance with applied pressure was observed as reaching 240% at 630 kPa (FIG. 7b). Experimental results with an 8×8 array demonstrated the utility of this method for distributed tactile sensing.

### Example 2—a Stretchable Tactile Sensor and a Method of Fabricating a Stretchable Tactile Sensor

A new multilayer fabrication technique was developed, building on existing soft lithography methods. The approach integrates a 3D printing-based casting technique that can be referred to as direct filament casting. Direct filament casting facilitates the fabrication of networks of liquid metal electrodes in very low modulus polymer membranes. The process involves the creation of separate functional components that are aligned, bonded, and functionalized through the introduction of liquid metal into conductive microchannels.

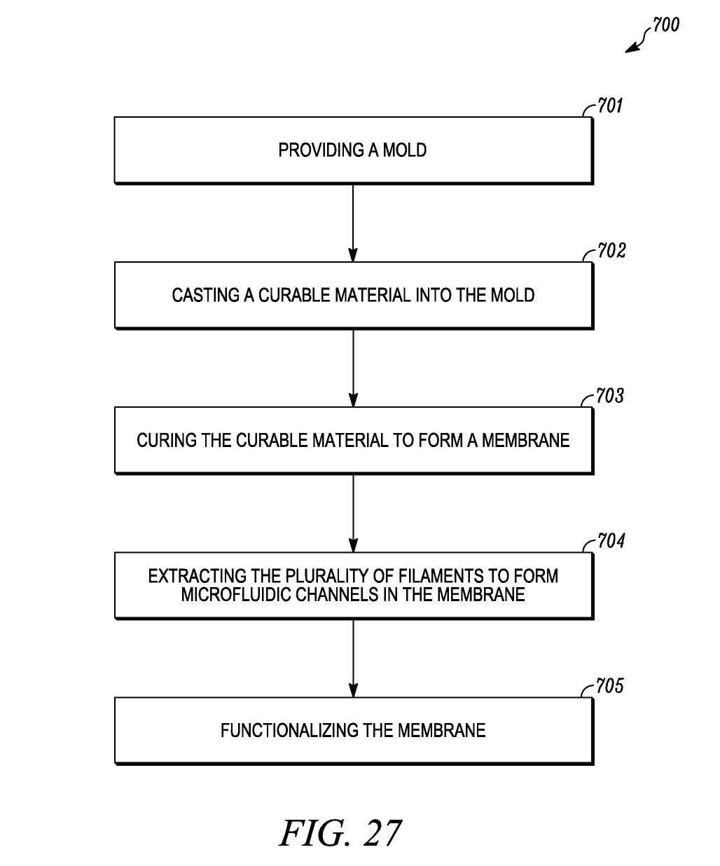

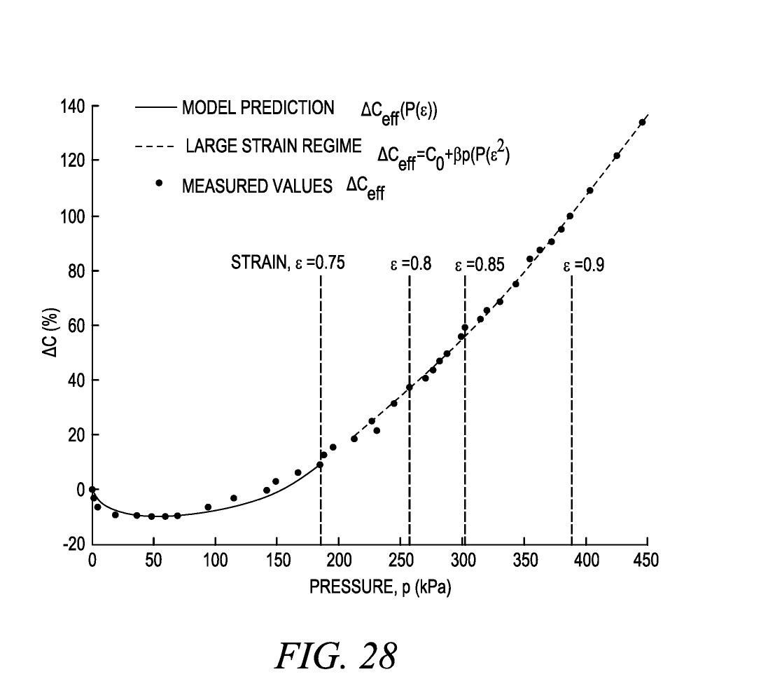

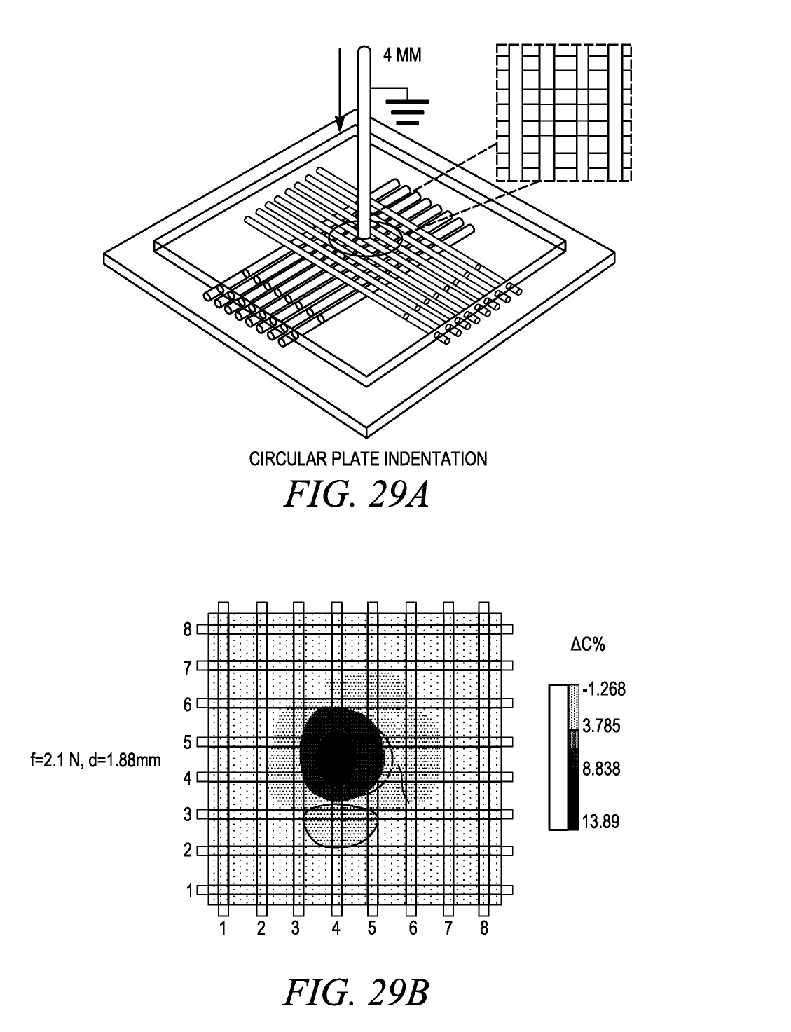

FIGS. 30(a)-(d) illustrate schematic diagrams of procedures for fabricating the upper and lower part of a stretchable tactile sensor, aligning and bonding the upper and lower parts of the stretchable tactile sensor, and functionalizing the sensing array by filling channels of a stretchable tactile sensor with a liquid metal alloy and inserting electrodes to form the electronic interface.

The preparation of the upper and lower components each proceeded with the creation of 3D CAD models of negative molds and a fixture frame that was used for casting (FIGS. 30(a), (b)). The negative molds and fixture frame was printed using a photopolymer 3D printer (Object30, Stratasys, Ltd.). The upper component contained the negative mold of the micropillar array. The mold surface was cleaned with isopropyl alcohol and dried, and a single monofilament (South Bend Monofilament, 200 or 300 μm diameter) spray-coated with surface release agent (Ease Release 200, Smooth-On, Inc.) was wound around the mold, following a path determined by fixture teeth in the mold. Additive liquid synthetic polymer components (Ecoflex 00-30, Smooth-On, Inc.) were mixed, degassed, and poured into the mold. A flat acrylic cover was used to close the mold, squeezing out extra polymer material. After curing for 6 hours, the filament was extracted from the mold. The cast mold was heated to about 60 C for about 15 minutes to facilitate demolding. The channels were sealed via syringe injection of liquid polymer, using a custom bracket and aligner. A bonding film of liquid polymer (thickness 100 μm) was spin-coated on the lower component (FIG. 30(c)) and the upper and lower components were aligned, centering each micropillar between microchannel intersections in the array. After partial curing (about 30 minutes), the parts were bonded and cured for six hours. The sensing array was then functionalized by filling all channels with liquid metal allow (eGaIn, 75% Ga, 25% In by mass, melting point 15.7 C) under syringe injection (FIG. 30(d)). The channels were terminated by inserting wires and further sealing. The resulting device was a 9×9 array and remained soft and highly compliant.

To facilitate robust data acquisition, four interface elements offset from the main membrane were introduced to aid in insulating the microchannels from mechanical stresses induced during testing, an important consideration during prototyping.

The design of the prototyle included upper and lower layers of microchannels (diameter d=300 μm, spacing s=2 mm), embedded in upper and lower polymer layers (t=500 μm). The micropillar layer had thickness tₚ=600 μm and an 8×8 array (Nₚ=65) of pillars with width wₚ=1 mm.

To validate sensor design, numerical simulations were performed using Multiphysics finite element analysis (FEA), including electrostatic, fluid, and solid mechanics effects. The simulation was used to investigate aspects of sensor performance, including sensitivity, linearity, and robustness, and their dependence on the sensor geometry. A CAD model was designed and introduced into a numerical simulation (COM-SOL Multiphysics, Comsol Inc.) with structure parameters that mirror those of the prototype design. For computing efficiency, this model included only three upper and three lower channels in the model, realizing nine sensing cells. The modeled device was otherwise identical to the prototype design described above with a thickness of 1.6 mm.

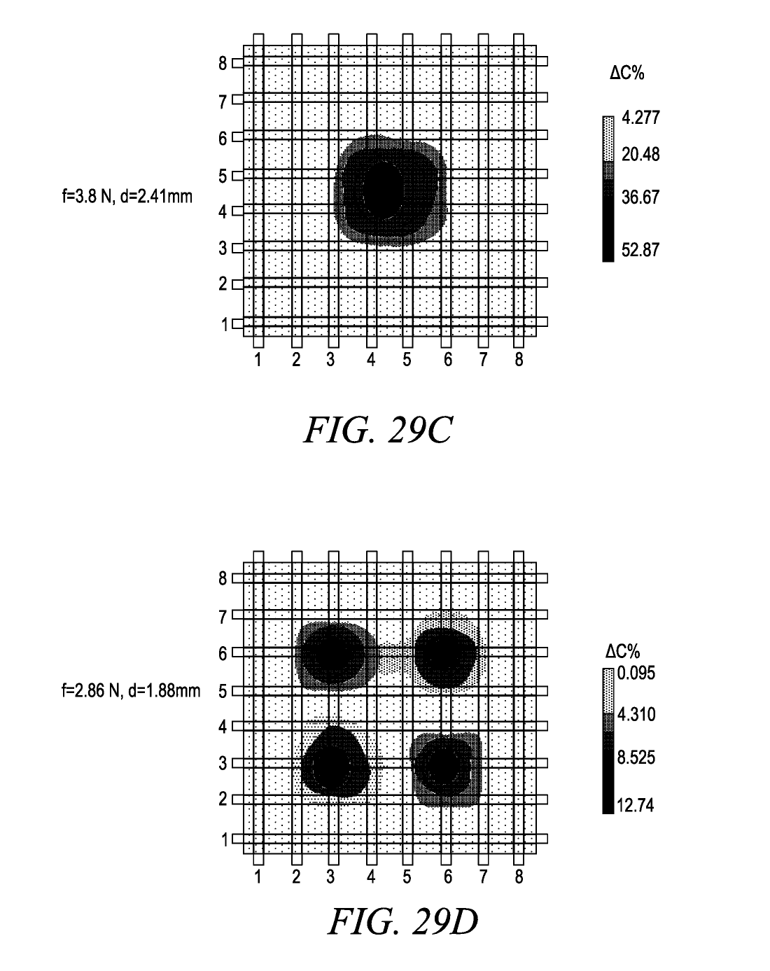

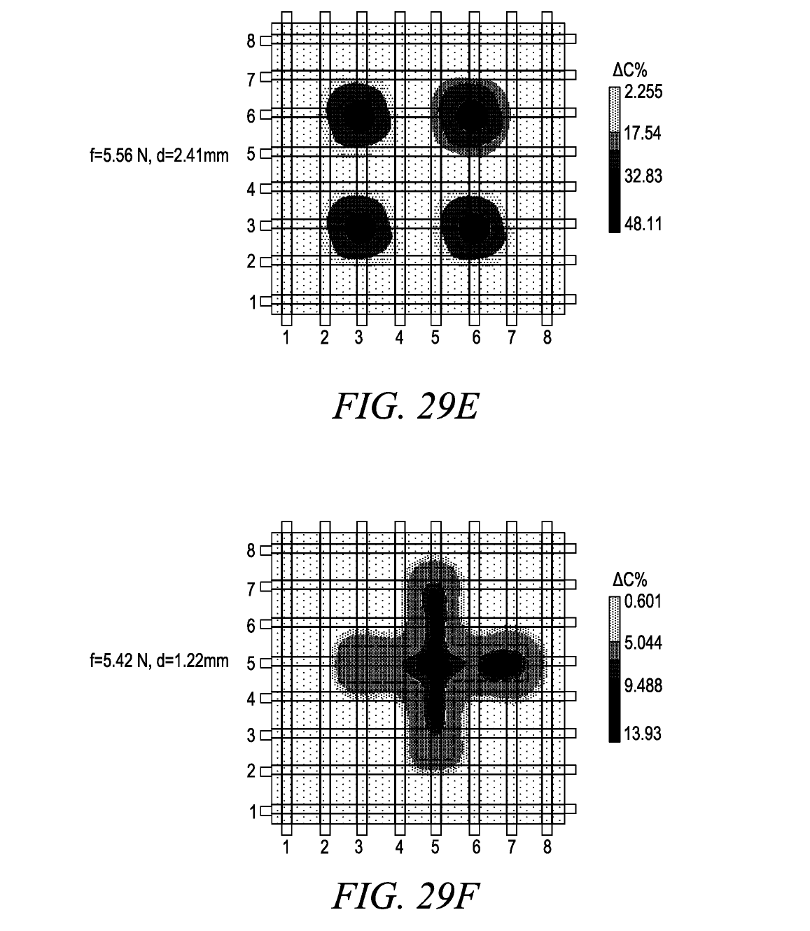

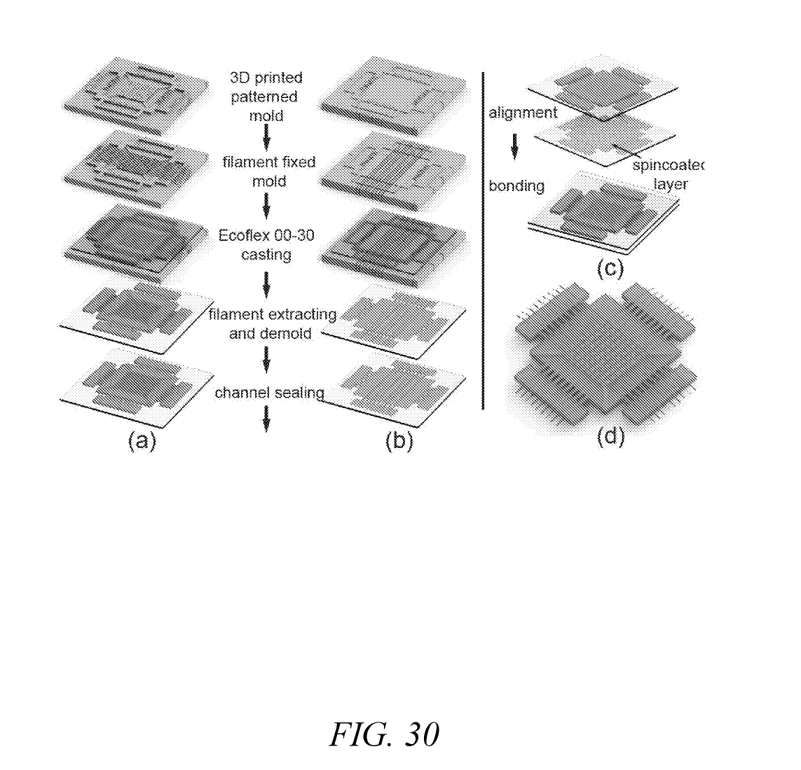

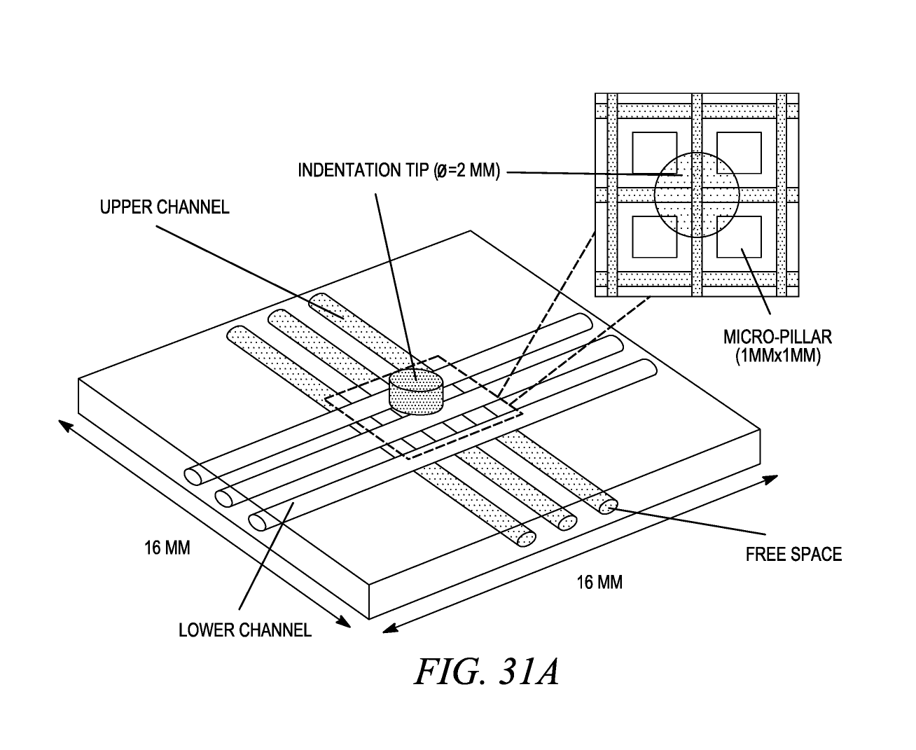

FIGS. 31(a)-(e) illustrate finite element model and simulation results, according to one or more embodiments of the present invention. FIG. 31(a) illustrates a perspective view of the structure of the simulated model, according to one or more embodiments of the present disclosure. The device response was simulated under indentation by a disc of diameter 2 mm that was placed concentrically above a sensing cell at the center of the array. The sensor was supported by a rigid platform and tested under simulated displacement-controlled loading up to 200 μm. From the simulation, strain and stress distributions, as well as capacitances for the 9 sensing cells, were obtained. To validate the design approach, the deformation of the microchannels and the coupling between pressed and unpressed sensing cells was analyzed.

FIG. 31(b) illustrates a cross-sectional view of displacement along a 45° diagonal section, according to one or more embodiments of the present disclosure. FIGS. 31(c)-(d) illustrate a top view of the displacement and stress, respectively, of the sensing cell under compression and its surrounding micropillars, according to one or more embodiments of the present disclosure. From the simulation results, compression reduced the distance between the upper and lower channel, yielding greater mutual capacitance. There was substantial vertical compression of the upper channel and the four surrounding micropillars. The eight unpressed sensing cells showed little displacement (less than about 1%), indicating that mechanical coupling between the channels was minimized, as intended, by the design. Under indentation, the small magnitude of stress at the compressed upper channel indicates that the channel geometry, and electrode integrity, remained intact under compressive loading.

FIG. 31(e) illustrates a graphical view of capacitance change (%) with normal indentation (μm), according to one or more embodiments of the present disclosure. Due to the decrease in distance between upper and lower channels, the capacitance increased monotonically with compressive strain. Capacitance increased at very small displacements, reflecting high sensitivity of the device. The capacitance of neighboring sensing cells remained nearly unaffected, indicating a high level of electronic decoupling that is achieved via this design.

The mechanical and electrical performance of the device was characterized under servo controlled indentation using stamps of variable geometry and flat or curved support surfaces. Custom electronics were designed for matrix-addressed capacitance sensing, using a dedicated integrated circuit (AD7746, Analog Devices) and microcontroller. This yielded a sensing system with excellent sensitivity (tens of femtofarad, fF) and resolution (approx. 10⁻¹⁸ F).

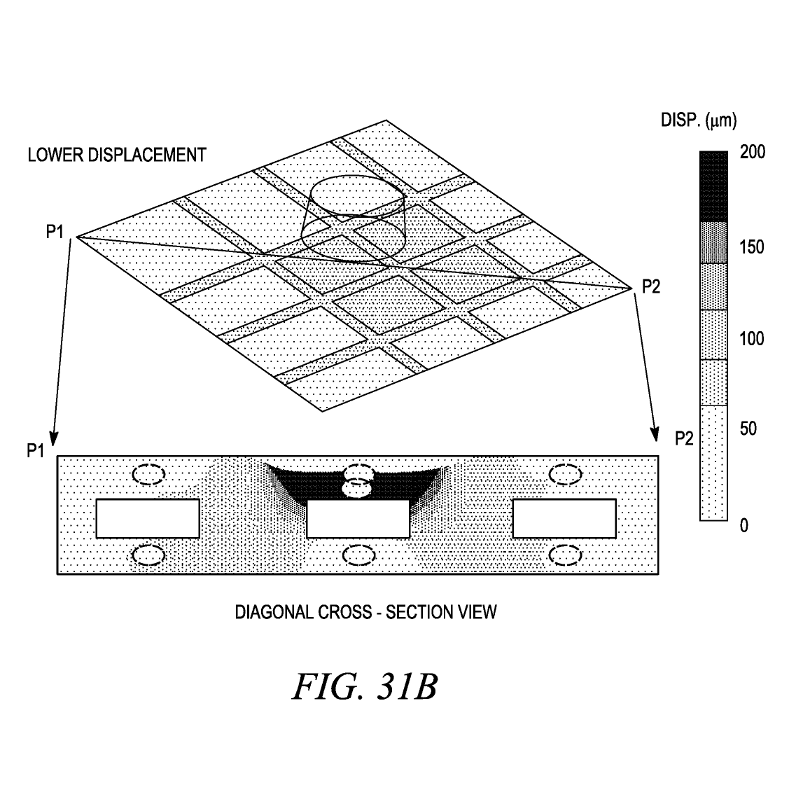

The performance of the 9×9 sensor array was tested in three configurations. Two of these assessed the sensitivity and dynamic range of individual sensing cells in the array, and one assessed the utility of the device for two-dimensional tactile imaging. In the single cell tests, the quasi-static and dynamic response were characterized during indentation testing a circular stamp of diameter of 2 mm. Displacement-controlled loading was performed via a programmable mechanical test system (ElectroForce 3200 Series III, Bose Corp.). FIG. 32 illustrates a schematic diagram of indenting tips used for characterization and an image of the programming mechanical testing system used in the experiments, according to one or more embodiments of the present disclosure. Capacitance was concurrently recorded using the electronics described above. Dynamic loads with a step function profile, and with ramp function profiles (load rates 200 μm/s to 10,000 μm/s) were used to assess the time-varying response. The dynamic response during loading and unloading was recorded to investigate hysteresis effects.

During the multi-cell tests, the use of the sensing array for tactile imaging was investigated by indenting the array with a cross-shaped stamp (width 10 mm, edge width 2 mm). The array was indented up to values reaching 300 μm. In a further test, device performance was assessed with the sensor supported on a curved acrylic surface, during indentation with the cross-shaped stamp to depths as high as 300 μm. In each experimental condition, averages of 10 measurements were recorded for analysis.

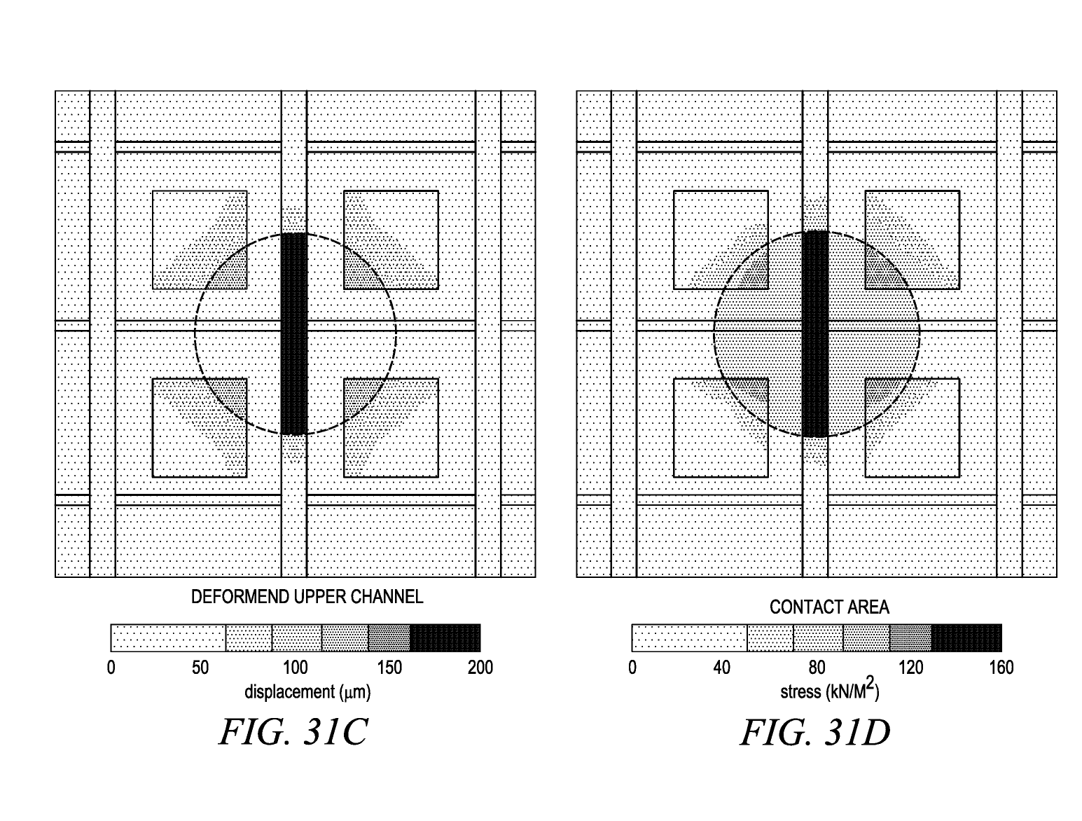

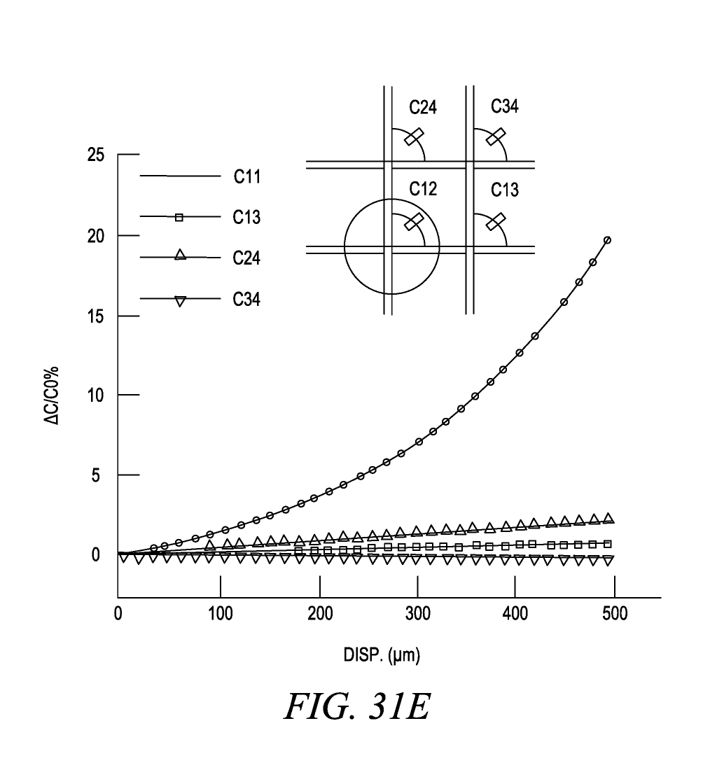

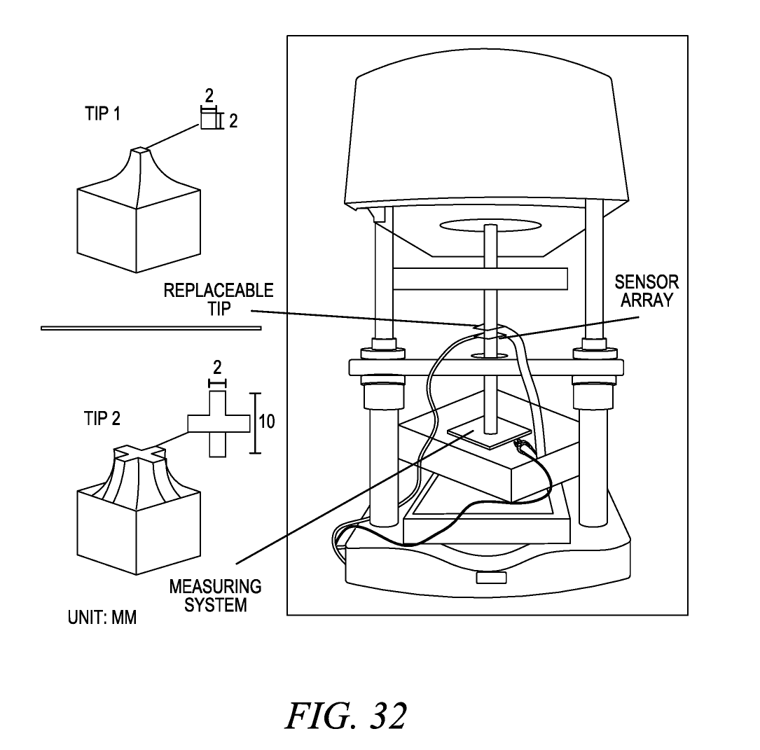

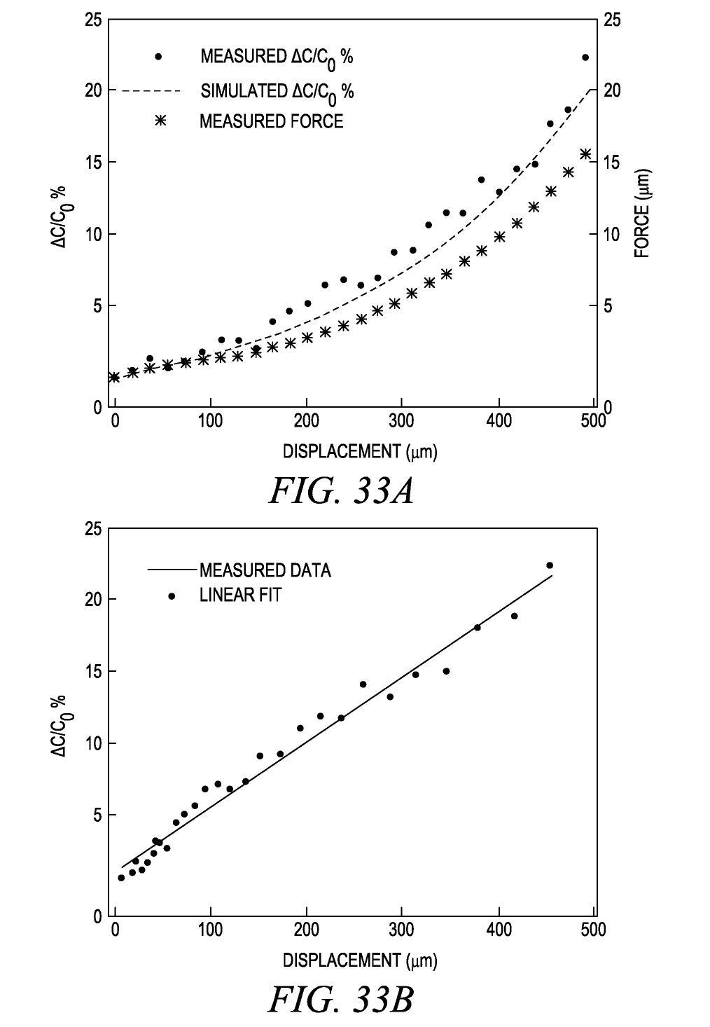

FIGS. 33(a)-(d) illustrate graphical views of the characterization of sensing cell performance under strain controlled loading, according to one or more embodiments of the present invention. FIG. 33(a) illustrates a graphical view of a measured change (black dot) in capacitance as a function of strain (μm) showing good agreement with simulations (dashed line) and also showing measured force (μN) (starred dots), according to one or more embodiments of the present disclosure. FIG. 33(b) illustrates a graphical view of the change in capacitance as a function of force showing a linear relationship up to 20 μN, according to one or more embodiments of the present disclosure. FIG. 33(c) illustrates a graphical view of the change in capacitance as a function of displacement (μm) showing the hysteresis of forward and backward indenting cycle, according to one or more embodiments of the present disclosure. FIG. 33(d) illustrates a graphical view of the change in capacitance as a function of displacement (μm) showing sensor response to strain applied at different rates (200 μm/s to 10,000 μm/s) demonstrating remarkably little strain-rate dependence, according to one or more embodiments of the present disclosure.

The quasi-static response of the device was well-captured via the change in capacitance with force and displacement during strain-controlled loading (FIG. 33(a)-(d)). The measured results show excellent qualitative and quantitative agreement with finite element simulations (FIG. 33(a)). Under displacement-controlled loading (FIG. 33(a)-(d)), measured and simulated capacitance rose monotonically by 25% under an imposed strain that increased to 30%. The change in capacitance with applied strain was mildly nonlinear, while a nearly linear variation in capacitance was observed as a function of force. This is consistent with the high-strain regime that was observed with simpler, solid cast devices. However, at low strains, the utility of the latter devices was greatly limited by non-monotonic behavior. In contrast, the monotonic performance that was observed with the device tested here validates the multi-layer design approached presented herein.

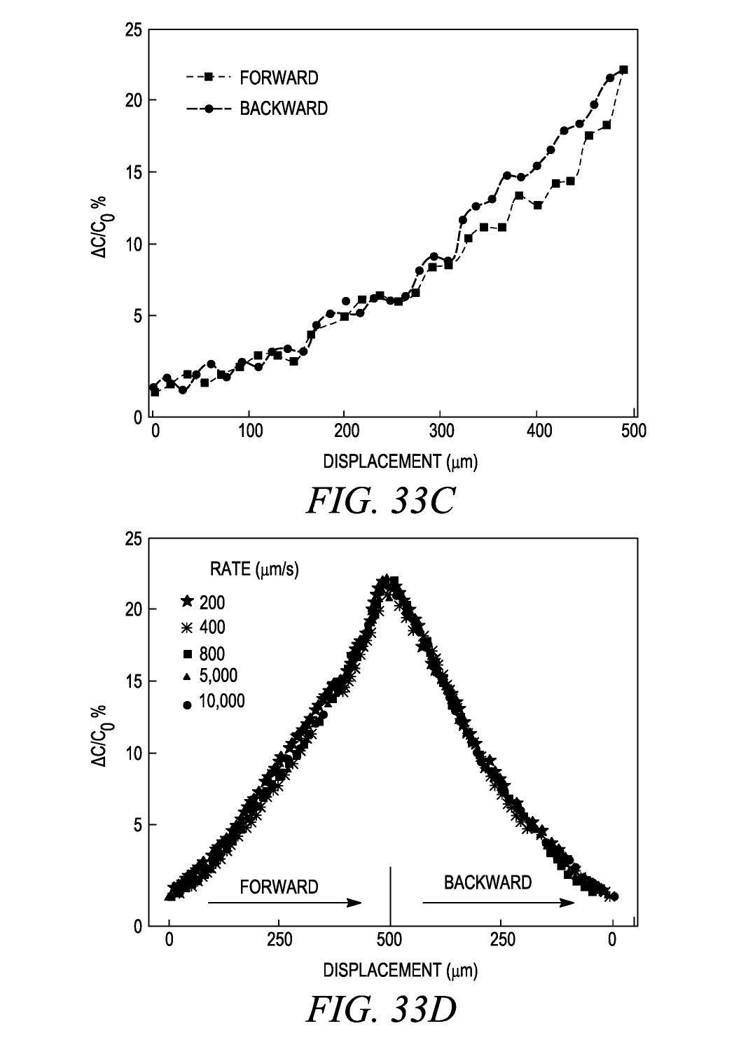

In analyzing the dynamic response of the sensor, minimal levels of hysteresis were found, which was typically only observable at the highest strain levels, 300 μm to 500 μm (FIG. 33(c)). There was almost no variation in sensor output with loading rates from 200 μm/s to 10,000 μm/s (FIG. 33(a)-(d)). The sensor output closely followed the indentation profile in both trapezoidal and ramp loading conditions (FIG. 31). FIGS. 34(a)-(b) illustrate graphical views of a single sensing cell tested with two different strain-controlled load functions: (a) showing trapezoidal load function with transient strain rate of 1000 μm/s and (b) showing ramp load function with strain rate of 200 μm/s, according to one or more embodiments of the present disclosure. During trapezoidal (quasi-step) loading, capacitance closely tracked displacement despite significant overshoot in force measurements, which are the normal result of rapid loading of a soft polymer.

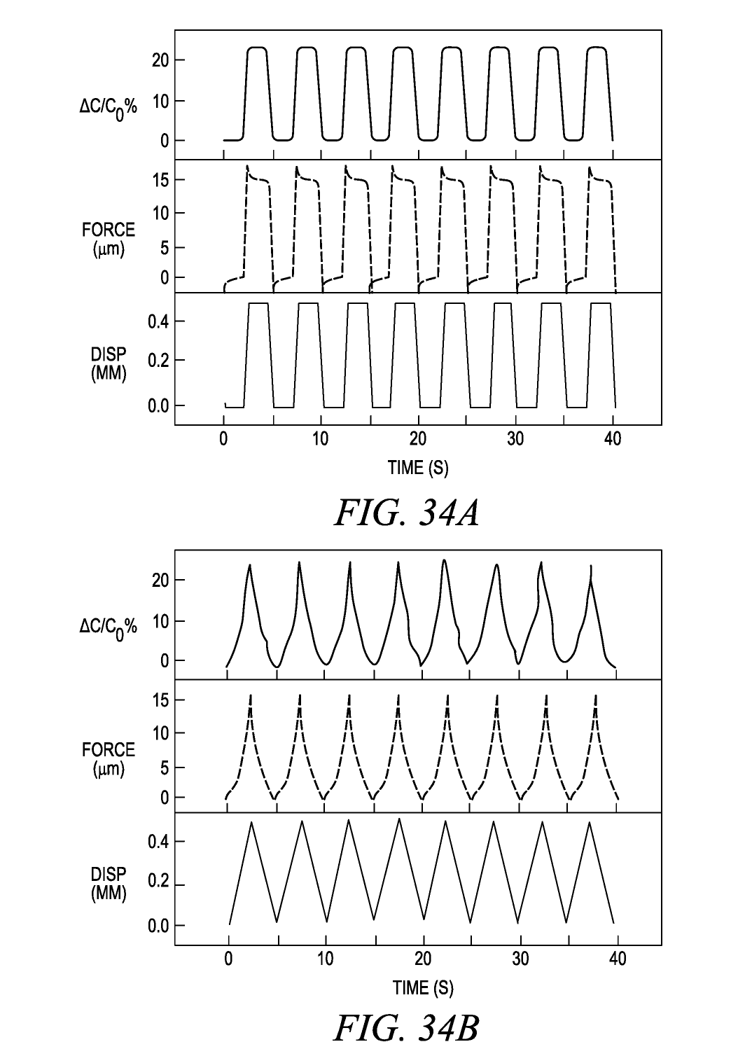

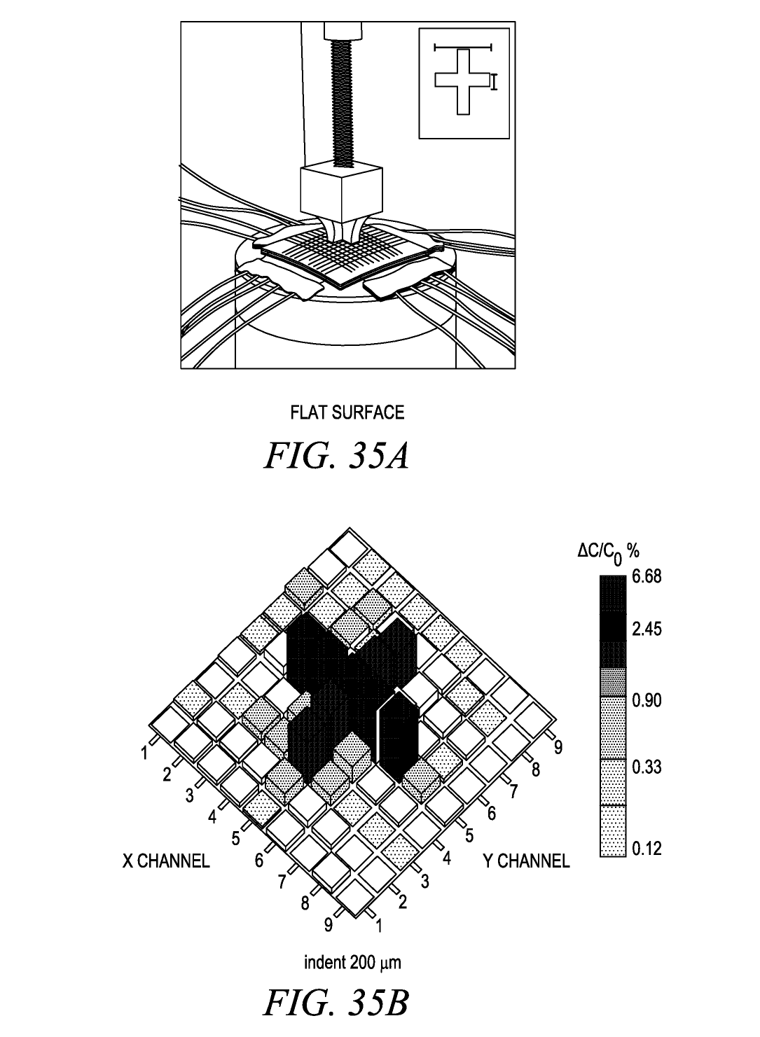

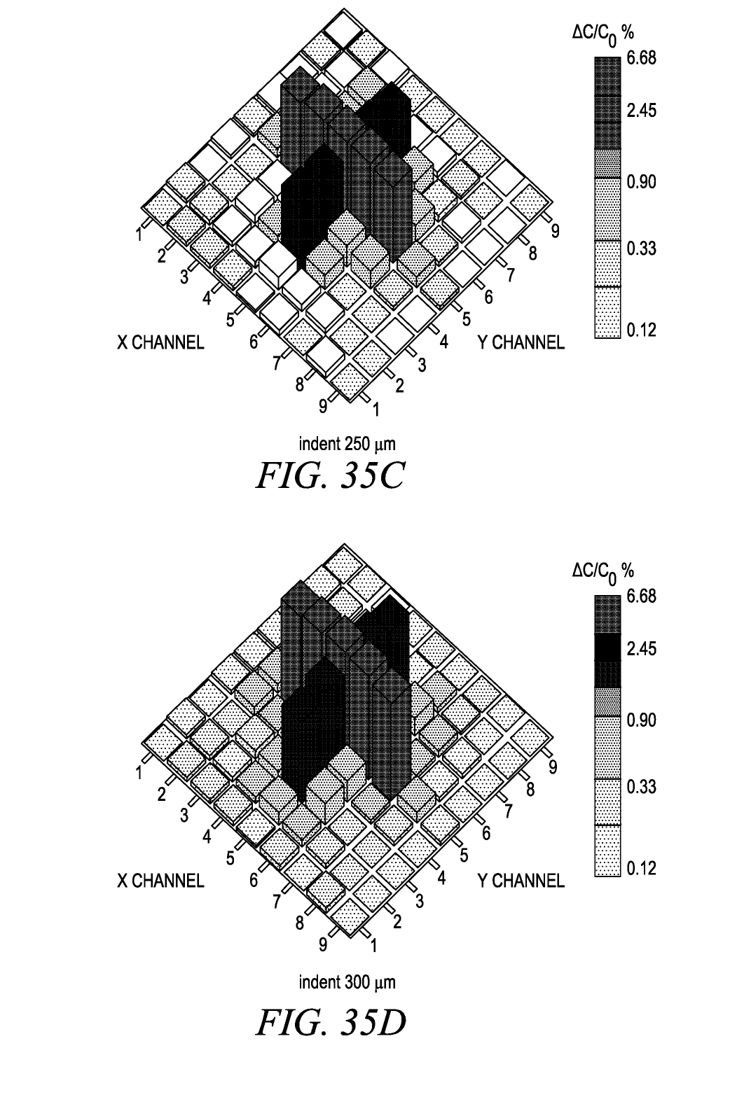

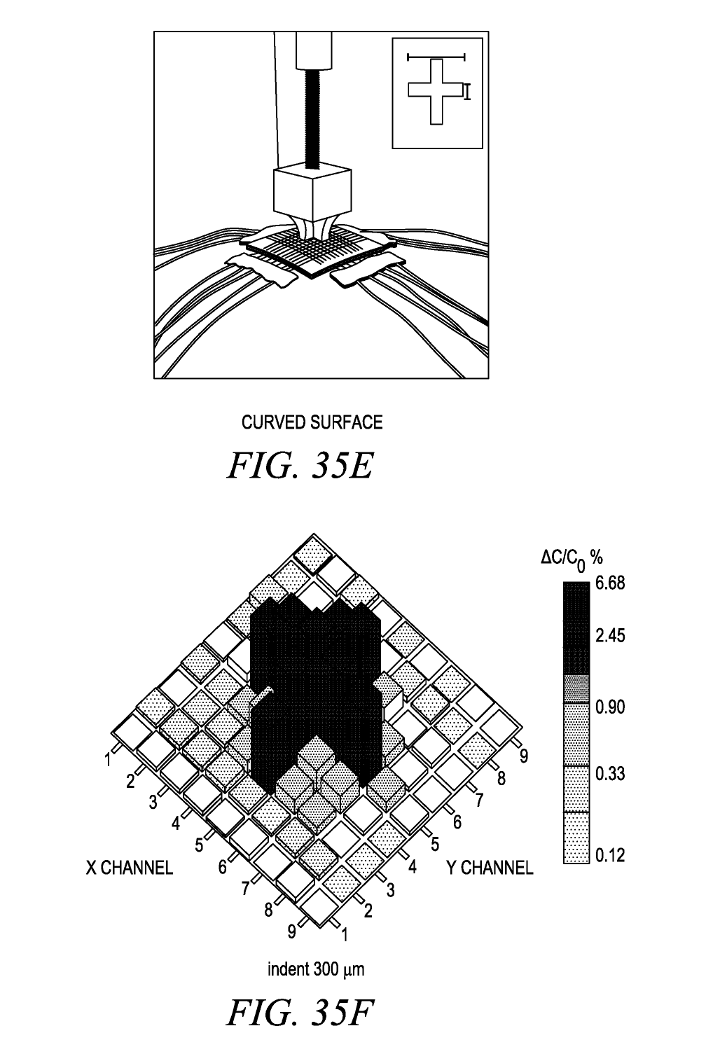

In a last set of experiments, the ability of the sensor array to perform tactile sensing of distributed loads while conforming to flat or curved surfaces was investigated. Output from the sensor array precisely mirrored the shape of the indentation stamp, and varied only in magnitude with indentation depth (FIGS. 35(a)-(f)). Cross-talk to adjacent (unpressed) sensing cells was minimal, less than about 1%. This was the case in spite of the intrinsic solid mechanical coupling of adjacent sensing cells in the array, which was minimized due to the thinness of the device. Similar tactile imaging performance was observed when the sensor was supported on a curved surface, with the sensor output changing solely due to the nearer approach of points at the apex of the support surface, which was near the center of the stamp.

The stretchable tactile sensors include soft micromechanical sensors for capacitive tactile imaging. The sensors used arrays of compliant electrodes embedded in multi-layer soft polymer membranes. The functional properties of these devices was facilitated via microfluidic channels and micropillars, which allowed for capacitance sensing and mechanical tuning. The methods of the present invention were robust, repeatable, and amenable to fabricating more complex geometries than can be easily realized with photolithography methods. Three-dimensional Multiphysics (mechanical and electrical, coupled) finite element simulations were performed to explain and analyze the mechanical and electrical performance, and the results were used to optimize the design of prototype sensors (9×9 sensing cells, 2×2 mm spatial resolution), which was subsequently fabricated and tested under distributed (2D) and time-varying loading conditions.

The observed performance was in close agreement with numerical predictions. The devices can achieve high sensitivity, monotonic output, a remarkably linear force-capacitance relationship, excellent tactile imaging, low cross talk, low load-rate dependence, and low levels of hysteresis. The devices performed similarly whether conforming to flat or curved surfaces.

The tactile sensors were robust, highly conformable, and can be used with respect to emerging applications in biomedical imaging of soft tissues during clinical palpation, to wearable sensing for human-computer interaction, and/or as electronic skin for robotic manipulators or prosthetic limbs, where it may facilitate interaction (grasping and manipulation) via touch. Through the selection of polymer materials and geometric parameters, the device can readily be adapted to meet application requirements, including compliance, sensitivity, resolution, and dynamic range.

Other embodiments of the present disclosure are possible. Although the description above contains much specificity, these should not be construed as limiting the scope of the disclosure, but as merely providing illustrations of some of the presently preferred embodiments of this disclosure. It is also contemplated that various combinations or sub-combinations of the specific features and aspects of the embodiments may be made and still fall within the scope of this disclosure. It should be understood that various features and aspects of the disclosed embodiments can be combined with or substituted for one another in order to form various embodiments. Thus, it is intended that the scope of at least some of the present disclosure should not be limited by the particular disclosed embodiments described above.

Thus the scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

The foregoing description of various preferred embodiments of the disclosure have been presented for purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto

Various examples have been described. These and other examples are within the scope of the following claims.

What is claimed is:

1. A tactile sensor comprising;
an elastomeric membrane having a channel formed therein;
a liquid conductive material located in the channel; and
electrodes electrically connected to the liquid conductive material, sufficient to form a stretchable electronic tactile sensor;
wherein the stretchable electronic tactile sensor can be stretched more than 50% in at least two axial directions from a resting state of the stretchable electronic tactile sensor.

2. The tactile sensor of claim 1, wherein the stretchable electronic tactile sensor can be stretched more than 100% in at least two axial directions from the resting state of the stretchable electronic tactile sensor.

3. The tactile sensor of claim 1, wherein the stretchable electronic tactile sensor can be stretched more than 200% in at least two axial directions from the resting state of the stretchable electronic tactile sensor.

4. The tactile sensor of claim 1, wherein the liquid conductive material includes one or more of a eutectic alloy, a conductive polymer, a conductive gel or paste, an ionic solution and conductive thread.

5. The tactile sensor of claim 1, wherein the channel forms a serpentine pattern.

6. The tactile sensor of claim 1, wherein the stretchable electronic tactile sensor is a resistive sensor and the conductive material is eutectic GaIn.

7. A tactile sensor, comprising:
an elastomeric membrane, the elastomeric membrane including
a first parallel array of microfluidic channels, and
a second parallel array of microfluidic channels, the first parallel array of microfluidic channels aligned perpendicular to the second parallel array of microfluidic channels; and
a conductive liquid in the first and second parallel arrays of microfluidic channels.

8. The tactile sensor of claim 7, wherein the conductive liquid includes one or more of a eutectic alloy, a conductive polymer, a conductive gel, a conductive paste, an ionic solution, and a conductive thread.

9. The tactile sensor of claim 7, wherein the conductive liquid includes eutectic gallium indium.

10. The tactile sensor of claim 7, further comprising an array of geometric structures positioned between the first parallel array of microfluidic channels and the second parallel array of microfluidic channels.

11. The tactile sensor of claim 10, wherein the array of geometric structures is an array of micropillar structures.

12. The tactile sensor of claim 7, wherein the tactile sensor is a capacitive sensor and the conductive liquid is eutectic GaIn.

13. A method of fabricating a tactile sensor, comprising:
providing a mold for fixing a plurality of filaments in parallel on a first plane and on a second plane, the filaments of the first plane aligned orthogonally to the filaments of the second plane;
casting a curable material into the mold;
curing the curable material to form a membrane;
extracting the plurality of filaments from the membrane to form microfluidic channels in the membrane; and
functionalizing the membrane by introducing a conductive liquid into the microfluidic channels of the membrane.

14. The method of claim 13, wherein the curable material is a low modulus synthetic polymer.

15. The tactile sensor of claim 13, wherein the conductive liquid includes one or more of a eutectic alloy, a conductive polymer, a conductive gel, a conductive paste, an ionic solution, and a conductive thread.

16. The method of claim 13, further comprising providing a mold for constructing an array of geometric structures on a third plane, the third plane positioned between the first plane and the second plane.

17. The method of claim 13, further comprising sealing the microfluidic channels of the membrane.

18. The method of claim 13, further comprising inserting electrodes to form an electrical connection with the conductive liquid.

19. The method of claim 13, further comprising terminating via insertion of wires and sealing.

20. The method of claim 13, wherein the tactile sensor is a capacitive sensor and the conductive liquid is eutectic GaIn.
